(19) United States
(12) Patent Application Publication
(10) Pub. No.: US 2025/0390829 A1
(43) Pub. Date: Dec. 25, 2025

(54) FOOD PRODUCT AND PACKAGING DEVELOPMENT

(71) Applicant: Frito-Lay North America, Inc., Plano, TX (US)

(72) Inventor: Sean Eichenlaub, Plano, TX (US)

(21) Appl. No.: 19/246,896

(22) Filed: Jun. 24, 2025

Related U.S. Application Data
(60) Provisional application No. 63/663,752, filed on Jun. 25, 2024.

(51) Int. Cl. G06Q 10/067; B65B 57/10; G06Q 50/04

(52) U.S. Cl. CPC G06Q 10/067; B65B 57/10; G06Q 50/04

(57) ABSTRACT

Disclosed are techniques for virtual food product development. A method may include: receiving, from an imaging system, two-dimensional (2D) data of food products in a production line at a plant, converting the 2D data of the food products into three-dimensional (3D) mesh data of the food products based on applying a neural network (NN) to the 2D data, generating a dataset of synthetic food product pieces based on applying an artificial intelligence (AI) model to the 3D mesh data of the food products, running a simulation of a process for packaging the synthetic food product pieces in the dataset, and returning simulation results in response to running the simulation.

### INCORPORATION BY REFERENCE

This application claims the priority benefit of U.S. Provisional Patent Application No. 63/663,752, filed Jun. 25, 2024, the entirety of which is incorporated herein by reference.

### TECHNICAL FIELD

This document generally describes devices, systems, techniques, and methods related to predicting product shape and simulating virtual product packaging using simulation engines, synthetic product data, machine vision techniques, machine learning models, or any combination thereof.

### BACKGROUND

Food products may be created and processed using various types of ingredients under different types of processing conditions. The food products may include, but are not limited to, snacks, chips, crackers, breads, etc. During processing and production of the food products, the processing conditions may be tailored cause the resulting food products to possess different shapes and/or geometries. Predicting the final shapes and/or geometries of the resulting food products prior to actually making them may be challenging. Moreover, the final shapes and/or geometries of the resulting food products may impact their handling, packaging, and/or consumer experiences.

### SUMMARY

The following describes systems, methods, algorithms, techniques, and technology for determining or predicting product shape and simulating processing and packaging of known, existing, and/or new food products (e.g., products) using simulation engines (e.g., gaming engines) and a variety of machine learning models, including but not limited to artificial intelligence (AI) models, neural networks (NN), and classification models. The disclosed techniques may be performed while food products are in a production line in a plant to predict packaging parameters and control attributes of the food product, such as shape, size, and/or density, to ensure compatibility with packaging. The disclosed techniques may also be performed to determine attributes for future food products, with the disclosed techniques being performed in real-time or near real-time as the food products move through the production line in the plant. The disclosed techniques may further automate equipment adjustments, such as cutter speed, extruder properties for food product diameter and/or density, and food product geometry properties, to meet predefined packaging specifications. Sometimes, the disclosed technology may provide for modifying packaging parameters and/or production timing, such as altering package size and/or introducing delays during filling and settling operations to ensure that a desired amount of the food product fits into the desired packaging parameters.

More particularly, an imaging or camera system may be used in a food processing facility (e.g., in a production line for producing the food products) to capture two-dimensional (2D) data of the food products during the processing cycle (e.g., image data, video data). Sometimes, the camera system may be configured to capture three-dimensional (3D) product geometry data of the food products as the food products move throughout the production line in the plant or facility. The 2D data from the camera system may be processed using trained synthetic data models and machine vision techniques to generate accurate three-dimensional (3D) food product models and other 3D product data (e.g., synthetic data of different pieces of the particular food product). In turn, the 3D models and data may be used in simulations to accurately predict behavior of the particular food product (e.g., food product pieces) during processing and packaging. Results from the described modeling and simulating may be used to accurately determine packaging parameters for different types of food products and/or processing conditions and/or modifications to the processing conditions to produce desired food products (for packaging and/or for consumers) and/or desired packaging size for the food products. As an illustrative example, the disclosed technology may be used to achieve customer satisfaction in providing smaller food products in smaller bags and larger food products in larger bags.

One or more of the described embodiments may include a method for virtual food product development. The method may include: receiving, from an imaging system, two-dimensional (2D) data of food products in a production line at a plant, converting the 2D data of the food products into three-dimensional (3D) mesh data of the food products based on applying a neural network (NN) to the 2D data, generating a dataset of synthetic food product pieces based on applying an artificial intelligence (AI) model to the 3D mesh data of the food products, simulating, in a simulation engine, a process for packaging the synthetic food product pieces in the dataset, and returning simulation results in response to simulating the process for packaging the synthetic food product pieces in the dataset.

The method may optionally include one or more of the following features. For example, the 2D data may include at least one video or at least one image of the food products as the food products undergo a production process in the production line in the plant. Converting the 2D data of the food products into the 3D mesh data of the food products may include: transforming the 2D data into point cloud data, and providing the point cloud data as input to the NN to generate the 3D mesh data of the food products. The AI model may include a Soft Point Flow NN that was trained per food product type to learn transformations of the 3D mesh data of the food products to representative shapes of the food products. The AI model may include an Unpaired Neural Implicit Shape Translation (UNIST) network that was trained to transform initial flat model shapes of the food products into finished 3D model shapes of the food products.

As another example, the simulating may include providing the dataset of synthetic food product pieces as input to a simulation model that was trained to determine packaging parameters for the food products based on the simulating, the packaging parameters including at least one of food product fill height in a package and food product headspace in the package. The method may also include generating recommendations for adjusting a process for producing the food products or adjusting the process for packaging the food products based on the simulation results. Generating the recommendations may include determining equipment controls or control modifications that cause, when automatically executed by equipment in the plant, an adjustment of size of the food products during production of the food products. The method may also include iteratively training the NN or the AI model based on user responses to the simulation results. Sometimes, the AI model may include a NN trained to perform at least one of: (i) transform initial shapes of the food products into finished 3D model shapes of the food products, (ii) predict a shape of finished food products based on a set of parameters, and (iii) predict a shape of unfinished food products based on a set of parameters, the set of parameters being based on desired finished food products. The AI model may be configured to generate output indicating a set of parameters required to produce a desired shape for the food products.

One or more of the described embodiments may include a system for virtual food product development. The system may include: an imaging system that may include at least one camera that may be configured to capture 2D data of food products in a production line at a plant and a computer system in network communication with the imaging system that may be configured to perform operations that may include: receiving, from the at least one camera of the imaging system, the 2D data of the food products, converting the 2D data into 3D mesh data of the food products based on applying a first model to the 2D data, generating a dataset of synthetic food product pieces based on applying a second model to the 3D mesh data of the food products, running a simulation of a process for packaging the synthetic food product pieces in the dataset, and returning simulation results in response to running the simulation.

The system may optionally include one or more of the following features. For example, the 2D data may include videos or images of the food products as the food products undergo a production process in the production line in the plant. Converting the 2D data of the food products into the 3D mesh data of the food products may include: transforming the 2D data into point cloud data, and providing the point cloud data as input to the first model to generate the 3D mesh data of the food products. The second model may include a Soft Point Flow NN that was trained per food product type to learn transformations of the 3D mesh data of the food products to representative shapes of the food products. The food products may include (i) existing food products that are produced and packaged in the production line at the plant or (ii) food products in a virtual development phase. The simulation further may include a process for producing the food products at the plant. Running the simulation may include providing the dataset of synthetic food product pieces as input to a simulation model that was trained to run the simulation to one or more simulation parameters. The simulation model may be trained to determine packaging parameters for the food products based on the simulation, the packaging parameters including (i) a food product fill height in a package or (ii) a food product headspace in the package. The operations further may include determining equipment controls that, when executed by equipment in the plant, automatically cause an adjustment of size of the food products during production of the food products.

One or more of the described embodiments may include a method for virtual food product development. The method may include: receiving, from an imaging system, two-dimensional (2D) data of food products in a production line at a plant, converting the 2D data of the food products into three-dimensional (3D) mesh data of the food products based on applying a neural network (NN) to the 2D data, generating a dataset of synthetic food product pieces based on applying an artificial intelligence (AI) model to the 3D mesh data of the food products, running a simulation in a gaming engine or other simulation engine of a process for packaging the synthetic food product pieces in the dataset, and returning simulation results in response to running the simulation in the gaming engine.

In some implementations, the described embodiments may optionally include one or more of the following features. For example, the 2D data may include at least one video or at least one image of the food products as the food products undergo a production process in the production line in the plant. The imaging system may include at least three cameras having different viewpoints and configured to generate 2D data of the food products from different angles that may correspond to the different viewpoints. Sometimes, converting the 2D data of the food products into the 3D mesh data of the food products may include: transforming the 2D data into point cloud data, and providing the point cloud data as input to the NN to generate the 3D mesh data of the food products. An AI model may include a Soft Point Flow NN that was trained per food product type to learn transformations of the 3D mesh data of the food products to representative shapes of the food products. The AI model may include an Unpaired Neural Implicit Shape Translation (UNIST) network that was trained to transform initial flat model shapes of the food products into finished 3D model shapes of the food products. The food products may include existing food products that may be produced and packaged in the production line at the plant. In some implementations, the food products may include food products in a virtual development phase, i.e., food products that are contemplated but have not yet been produced.

Sometimes, running the simulation in the gaming engine (e.g., simulation engine) may include providing the dataset of synthetic food product pieces as input to a simulation model that was trained to run the simulation in the gaming engine according to one or more simulation parameters. The simulation model may be or was previously trained to determine packaging parameters for the food products based on the simulation, with the packaging parameters including at least one of food product fill height in a package or food product headspace in the package. Running the simulation in the gaming engine may include setting one or more parameters for the simulation, the parameters including at least one of: geometry parameters for equipment in the production line at the plant, food product geometry parameters, food product quantity parameters, motion parameters for the equipment in the production line at the plant, or food product material parameters.

The method may also include generating recommendations for adjusting a process for producing the food products or adjusting the process for packaging the food products based on the simulation results. Generating the recommendations may include determining a package size or length (or other dimensions) for the food products that may satisfy one or more food product production criteria. Generating the recommendations may include determining equipment controls or control modifications that may cause an adjustment of the size of the food products during production of the food products. In some implementations, the method may include automatically executing instructions to perform one or more of the recommendations at the plant during production of the food product and/or packaging to contain the food product. In one aspect, the method may include iteratively training the NN or the AI model based on the simulation results. The method may additionally or alternatively include iteratively training the NN or the AI model based on user responses to the simulation results.

In some implementations, the AI model may include a NN trained to transform initial shapes of the food products into finished 3D model shapes of the food products. The AI model may include a NN trained to predict a shape of finished food products based on a set of parameters. The AI model may include a NN that may be trained to predict a shape of unfinished food products based on a set of parameters, the set of parameters being based on desired finished food products. The AI model may be configured to provide a set of parameters that may be required to produce a desired shape for the food products. In some implementations, the method may also include predicting a shape of the food products based on applying the AI model.

One or more of the described embodiments may include a system for virtual food product development. The system may include: an imaging system that may be configured to capture 2D data of food products in a production line at a plant, with the imaging system including: at least three cameras having different viewpoints and that may be configured to generate the 2D data of the food products from different angles that correspond to the different viewpoints. The system may also include a computer system in network communication with the imaging system, with the computer system being configured to perform operations that may include: receiving, from the at least three cameras of the imaging system, the 2D data of the food products, converting the 2D data of the food products into 3D mesh data of the food products based on applying a trained NN to the 2D data, generating a dataset of synthetic food product pieces based on applying a trained model to the 3D mesh data of the food products, running a simulation in a gaming engine of a process for packaging the synthetic food product pieces in the dataset, and returning simulation results in response to running the simulation in the gaming engine.

The system may optionally include one or more of the following features. For example, the trained NN may include a Neural Radiance Field (NeRF) NN. The 2D data may include videos or images of the food products as the food products undergo a production process in the production line in the plant. Converting the 2D data of the food products into the 3D mesh data of the food products may include: transforming the 2D data into point cloud data, and providing the point cloud data as input to the trained NN to generate the 3D mesh data of the food products. The at least three cameras may be arranged with respect to the production line to define an opening through which the food products may pass through as the at least three cameras generate the 2D data of the food products. The trained model may include a Soft Point Flow NN that was trained per food product type to learn transformations of the 3D mesh data of the food products to representative shapes of the food products. The food products may include existing food products that may be produced and packaged in the production line at the plant. The food products may include food products in a virtual development phase.

Sometimes, the simulation further may include a process for producing the food products at the plant. Running the simulation in the gaming engine may include providing the dataset of synthetic food product pieces as input to a simulation model that was trained to run the simulation in the gaming engine according to one or more simulation parameters. The simulation model may be or was previously trained to determine packaging parameters for the food products based on the simulation. The packaging parameters may include a food product fill height in a package and/or a desired amount, e.g., by weight, of the food product to achieve a desired fill height. The packaging parameters may include a food product headspace in a package. The operations may also include generating recommendations for adjusting a process for producing the food products based on the simulation results. Generating the recommendations may include determining equipment controls or control modifications that may cause an adjustment of size of the food products during production of the food products and/or an adjustment to the shape and/or size of the packaging to contain the food products. The operations further may include: generating recommendations for adjusting the process for packaging the food products based on the simulation results. Generating the recommendations may include determining a package size or dimensions, e.g., length or thickness, for the food products that may satisfy one or more food product production criteria.

One or more of the described embodiments may include a method for virtual product development. The method may include: receiving 2D data of a product, converting the 2D data of the product into 3D mesh data of the product, generating a dataset of synthetic product pieces based on the 3D mesh data of the product, running a simulation in a gaming engine using the dataset of synthetic product pieces, and returning simulation results in response to running the simulation.

The method may optionally include one or more of the following features. For example, the product may include food products. The dataset of synthetic product pieces may include a dataset of synthetic food product pieces. Running the simulation may include simulating a process for producing or packaging the food products based on the dataset of synthetic food product pieces. The 2D data may be generated by at least one camera. Converting the 2D data into the 3D mesh data may be based on applying a NeRF NN to the 2D data. Generating the dataset of synthetic product pieces may be based on applying an AI model to the 3D mesh data of the product. The AI model may include a generative model. In some implementations, the AI model may include a Soft Point Flow NN.

One or more of the described embodiments may include a method for predicting a food product shape. The method may include: receiving, from an imaging system, two-dimensional (2D) data of food products in a production line at a plant, converting the 2D data of the food products into three-dimensional (3D) mesh data of the food products based on applying a neural network (NN) to the 2D data, generating a dataset of synthetic food product pieces based on applying an artificial intelligence (AI) model to the 3D mesh data of the food products, predicting a shape of the food products based on applying the AI model, and returning the predicted shape of the food products. The method may optionally include one or more of the abovementioned features.

The described devices, system, and techniques may provide one or more of the following advantages. For example, the disclosed technology is tied to specific real world industrial applications, such as controlling physical food production equipment and packaging equipment including but not limited to mixers, formers, extruders, sheeters, conveyors, cutters, weigh stations, filling stations, and/or sealing stations. Moreover, the disclosed technology improves the technological process of food packaging by providing real-time or near real-time control of machinery/equipment based on predictive modeling, unlike conventional systems that rely on manual and/or static configurations of food production and packaging lines. In other words, conventional systems use fixed parameters and/or manual adjustments for food development and packaging. The disclosed technology, on the other hand, uses automated predictive modeling techniques to dynamically adapt real-time product attributes in the production line, thereby resulting in greater efficiency, reduced waste in energy consumption, food products and packaging materials, and precise packaging conformity. The predictive modeling includes unique food product-specific simulations to calculate and determine parameters such as headspace in packages and/or food product extrudate shape/density in order to apply real-time or near real-time physical changes in packaging and machinery settings in the food production line. Likewise, the disclosed technology does not merely simulate and display results, it also directly influences mechanical/equipment operations, such as, but not limited to, adjusting cutter speeds, on the production line, thereby establishing a practical application of the disclosed computing technology.

The disclosed technology thereby provides accurate and fast simulations to enable development and virtual development of food products and their associated packaging. The disclosed automated imaging and/or camera systems may be used to accurately capture food product geometries in less time than other camera systems (such as by capturing images of food products as they are being routed throughout a production/processing cycle in a facility). Data generated by the disclosed camera systems may be used with AI and other synthetic data models to generate extensive datasets of synthetic food product pieces that do not exist. Reproducing geometries of the food products may result in generating accurate product interactions and simulation predictions. Generating synthetic 3D food product pieces (whether for known/existing or new products) may advantageously be used to accurately simulate a process for producing the food products. The simulations may be accomplished using simulation engines, including but not limited to gaming engines, to understand how the food products may be affected by processing conditions and may interact with packaging systems. The disclosed technology may also be used to generate comprehensive understandings of the effects that processing conditions used to form the food products may have on the final product shape, which is important for determining optimal product packaging and for providing products that consumers want. The disclosed technology may be used to generate synthetic data of food products for use in a variety of applications, including but not limited to product processing, product packaging, and training of other machine learning models and/or machine vision models.

Using simulation engines to simulate food product processing and/or packaging may result in accurate simulations being run in less time than traditional simulations (such as discrete element method, DEM, simulation models). As a merely illustrative example, some traditional simulations may take anywhere from 2 hours to 72hours to run through a full simulation of processing and packaging food products. The disclosed technology, on the other hand, leverages simulation or gaming engines to run full and accurate simulations in 10 minutes or less. The disclosed technology may reduce simulation run time by at least 100x, in some implementations. Faster simulations may also result in improved decision making about whether and how to modify conditions for processing the food products and/or packaging the food products.

The simulation or gaming engines further may allow for running many simulations simultaneously for many different products (existing food products, soon-to-be-created food products, etc.) with minimal to no lag time. The disclosed technology is computationally efficient to perform such simulations simultaneously while also allowing for improved and accurate insight into processing and packaging operations and conditions of the different products. As a result of such lightweight, accurate, and efficient simulating, the disclosed technology allows for actions to be taken (automatically) in real-time or near-real time during or before the processing and/or packaging operations to modify such operations and achieve the production of desired products and desired packaging parameters.

Similarly, the disclosed technology may allow for performing development and virtual product development for the many different products, thereby reducing or otherwise eliminating a need for real-world experiments or manual testing of the product processing and/or packaging operations. By eliminating manual testing, the disclosed technology reduces or otherwise eliminates product wastage that may arise from having to manually test the processing and packaging of the products. The disclosed technology may reduce an amount of material needed for product packaging while also having a positive environment impact. As another example, the disclosed technology may provide for improved certainty in what products will look like as well as other characteristics. This increased certainty and predictability may have numerous additional benefits. For example, the benefits may include but are not limited to optimizing processing parameters to reduce energy, food, water waste, and/or packaging materials. As another example, the benefits may include the ability to create small batches of products and specialized promotional products while using fewer resources and eliminating a need for real-world product testing and development. Not tying up a product line to run physical real-world tests may also enhance commercial production and increase commercial volume and throughput. Additionally, the disclosed technology may allow for improved consumer satisfaction and value by allowing more food products to be efficiently packed into smaller packages. This may also reduce costs and result in savings that may be passed on to the consumer.

To provide robust generation of synthetic food product pieces and product packaging simulations, the disclosed technology may use a complex collection of algorithms, AI models, and/or other machine learning techniques to process and analyze data associated with different food products, food product processing cycles, and/or food product packaging. This complex collection of algorithms, AI, models, and/or other machine learning techniques may provide an unconventional solution to accurately and efficiently predict or otherwise determine food product shapes and geometries, food product processing cycles, and/or packaging of the food products.

After the disclosed technology generates synthetic food product pieces and simulates product packaging using the synthetic data, the disclosed technology may display relevant information and data using a GUI on a display of computing devices of relevant users in a unique and easy to understand format. Conventional systems may not provide the disclosed solutions for at least the following reasons: (i) the signifimayt processing power required to continuously collect data of the food products, generate synthetic data of the food products, and simulate the food products during processing and packaging, (ii) the considerable data storage requirements for maintaining information collected and determined by the disclosed technology, (iii) the lack of a large enough pool of data to provide accurate thresholds for the disclosed algorithms, AI, models, and/or other machine learning techniques, and/or (iv) the lack of algorithms, AI, models, and/or other machine learning techniques that allow for the thresholds to be automatically updated in light of additional data that may be added to the pool of relevant data. In addition, translation of outcomes from the disclosed complex algorithms, AI, models, and/or machine learning techniques through GUIs may improve comprehension of considerable quantities of highly processed data. For example, an exemplary model described herein may include: taking inputs from multiple sensors, selecting some data provided by the sensors, ignoring some of the data that was provided by the sensors, performing multiple calculations on a selected subset of the data, combining the data from these multiple calculations and then outputting that data within a short amount of time (e.g., less than a minute), all for multiple relevant users.

The disclosed technology provides a technical solution to a technical problem related to efficiently and accurately determining how food products may be produced during a processing cycle and/or how the final food products may fit into respective packaging and/or how the final food products may be more efficiently produced and/or packaged. The disclosed technology leverages a complex set of individually-trained models and/or algorithms to address the technical problem. Accordingly, the disclosed technology may require analyzing millions of data points to identify characteristics of food products, determine other potential characteristics (e.g., shapes, geometries) of the existing food products and/or new food products, simulate the processing of such food products, simulate the packaging of the food products, determine how the processing and/or packaging may be modified to achieve desired results for the food products, obtain additional data from sensors to further train and enhance the many trained models that are used to generate synthetic food product pieces and the simulations, to generate and output information to the relevant users based on at least the simulations, and then repeat the above operations over a relatively short time period (e.g., every day, every half day, every hour, every 10 minutes, every 5 minutes, every 1 minute) and for many different food products that are being processed or designed (and not yet processed, such as new food products).

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a conceptual diagram of a system for imaging products, generating synthetic data about the products from the image data, and simulating packaging parameters for the products.

FIG. 2A illustrates an example imaging system for imaging products.

FIG. 2B illustrates an example imaging apparatus for imaging products.

FIG. 3 is a conceptual diagram of a system for determining product attributes based on processing image data of the products.

FIG. 4 is a conceptual diagram of a system for training a model to generate synthetic product data and using the trained model during runtime.

FIG. 5 is a conceptual diagram of a system for training a model to predict new product characteristics, such as shape, and using the trained model during runtime.

FIG. 6A illustrates a process for training a model to predict new product characteristics.

FIGS. 6B and 6C illustrate results from using a model trained to predict how a product shape may change due to processing.

FIG. 6D illustrates example results from using a model in reverse to identify what the model has learned about shape change during product processing.

FIGS. 7A and 7B is a flowchart of a process for determining packaging parameters for products.

FIG. 8 illustrates a process for determining an impact of a new product's characteristics on packing without physically producing the new product.

FIG. 9 illustrates a block diagram of an example product packaging simulation.

FIGS. 10A and 10B are system diagrams illustrating system components that may be used to perform the disclosed techniques.

FIG. 11 is a schematic diagram that shows an example of a computing device and a mobile computing device.

Like reference symbols in the various drawings indicate like elements.

### DETAILED DESCRIPTION

This document generally relates to technology for efficiently and accurately generating 3D models of food products (e.g., products, food product pieces) and using the 3D models of the food products with simulation engines (e.g., gaming engines) to simulate processing and/or packaging of the food products. The disclosed technology may be used to predict shapes of the food products before, during, and/or after respective production/processing of the food products. The disclosed technology may train and use various different models, including but not limited to machine learning models, AI models, classification models, synthetic models, generative models, NNs, etc. Although gaming or simulation engines are described, these are merely non-limiting illustrative implementations and examples. One or more model equations based on game engines or other physics-based simulation engines, modules, models, and/or algorithms may be used, which may not require running a full simulation model or an actual game engine.

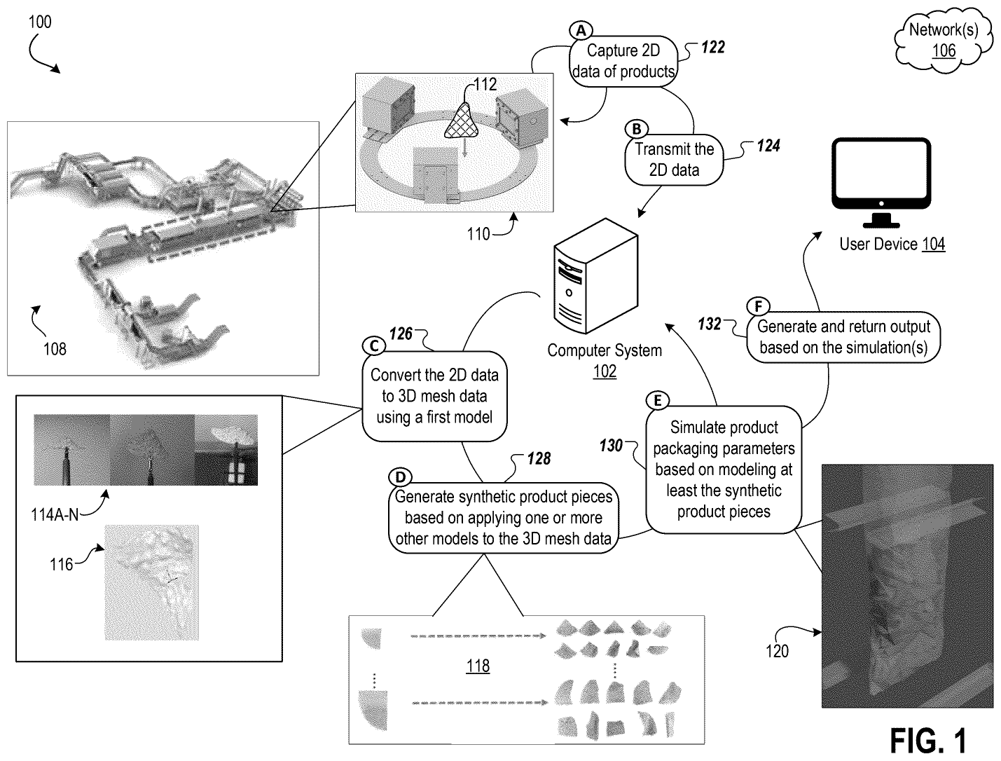

Referring to the figures, FIG. 1 is a conceptual diagram of a system 100 for imaging products, generating synthetic data about the products from the image data, and simulating packaging parameters for the products. The system 100 may further be used to predict packaging parameters for food products and/or determine controls for food product attributes to ensure the food products fit into their packaging. Sometimes, the system 100 may be used to determine food product attributes (e.g., shape, size) for future food products to be produced. The disclosed techniques may be performed in real-time or near real-time, as the food products are moving through a production line at a plant. As a result, sometimes the simulations and other modeling performed and described herein may cause automated controls of equipment in the production line once the food products are routed to/arrives at the equipment. For example, the disclosed techniques may be performed to determine a cutter speed to adjust length (or other dimensional attributes) of products such that the products may fit into predefined packaging parameters (and result in a predefined amount of headspace inside a package). As another example, the disclosed techniques may be performed to adjust other conditions for an extruder, such as adjusting a diameter and/or density of the extruded product such that the extruded product fits into the predefined packaging parameters. As yet another example, the disclosed techniques may be performed to determine and adjust geometry of some products, such as potato chips and/or tortilla chips, before they are produced in the food production line. In some implementations, the disclosed techniques may be performed to determine packaging parameter adjustments, such as modifying a size and/or shape of the packaging, causing a predetermined time modulation between, for example, weigh buckets releasing food products into the packing and in-bag settling operations, etc.

Trained models, as further described, may be used to model the shapes and geometries of any type of products, such as existing food products (e.g., snack chips, crackers, other snack foods) and/or new food products (e.g., soon-to-be created products). As an example, the disclosed modeling techniques may be used to generate synthetic data of the existing and/or new food products, the synthetic data representing many possible shapes and/or geometries of the existing and/or new food products. The synthetic data may then be used by the system 100 to simulate how the existing and/or new food products may be produced during a processing lifecycle and/or how the existing and/or new food products may be packaged. A gaming engine may sometimes be used to perform accurate, valid, and fast simulations.

In the system 100, a computer system 102 may communicate with at least an imaging system 110 (e.g., camera system) and a user device 104 over network(s) 106 (e.g., wired, wireless communication). The computer system 102 may be any type of computing device, system, network of devices, and/or cloud-based system. The computer system 102 may be configured to process data of food products to generate synthetic product pieces and simulate processing and packaging of the synthetic product pieces. In some implementations, the computer system 102 may be remote from a location where the food products are being processed, packaged, and/or imaged. In some implementations, the computer system 102 may be on the edge, onsite where the food products are being processing, packaged, and/or imaged.

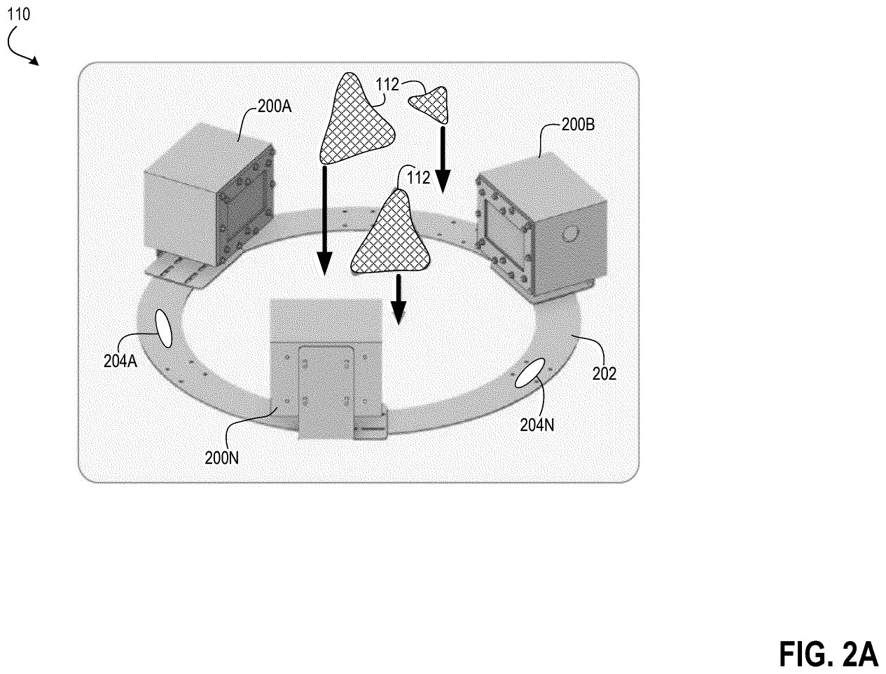

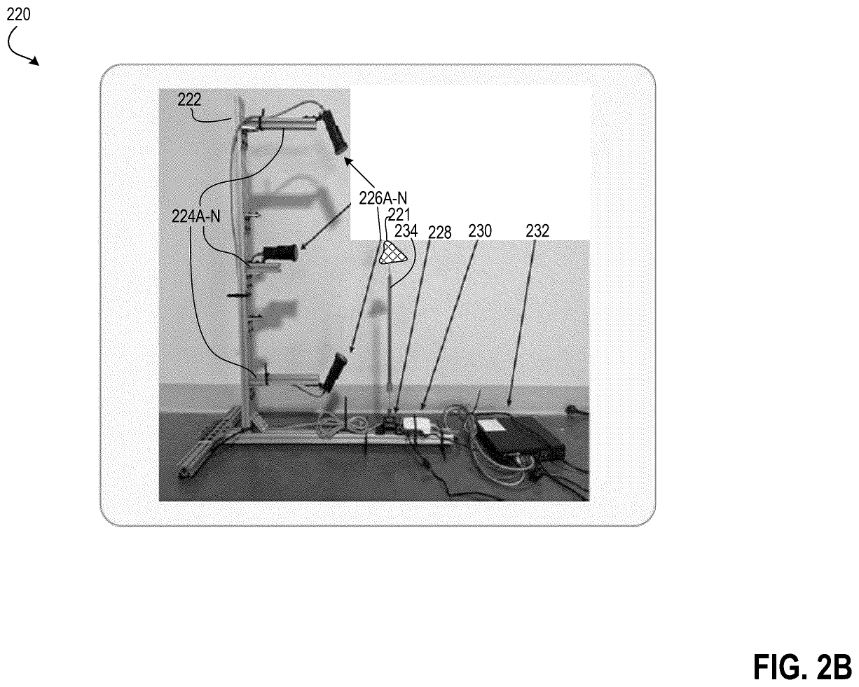

The imaging system 110 may be positioned in a facility 108 (e.g., plant) where food products 112 may be produced, processed, and/or packaged. For example, the imaging system 110 may be positioned in or along a food product production line in the facility 108. The imaging system 110 may include one or more cameras configured to capture 2D data of the food products 112 (e.g., pieces of the food products 112) as the food products 112 are automatically routed throughout the facility 108. Thus, the cameras of the imaging system 110 may measure attributes of the food products 112 as they make their way through the production line and into packaging. Refer to FIGS. 2A and 2B for further discussion about the imaging system 110 and alternative camera systems.

The user device 104 may be any type of computing systems, device, and/or cloud-based system. The user device 104 may include but is not limited to smartphones, mobile devices, laptops, tablets, etc. The user device 104 may be used by a relevant user associated with the facility 108. The user device 104 may be configured to present relevant information to the user about the food products 112 production, processing, and/or packaging processes based on modeling and other operations performed by the computer system 102.

Still referring to the system 100 of FIG. 1, the imaging system 110 may capture 2D data 114A-N of the food products 112 (e.g., products) in block A (122). The 2D data 114A-N may include videos and/or images of the food products 112. In some implementations, the imaging system 110 may continuously capture the 2D data 114A-N of the food products 112. Sometimes, the imaging system 110 may capture the 2D data 114A-N intermittently, e.g., at predetermined time intervals (e.g., every 10 seconds, every 15 seconds, every 30 seconds, every 1 minute). Refer to FIGS. 2A and 2B for further discussion about the imaging system 110. The 2D data 114A-N may be captured of the food products 112 at one or more different angles and/or viewpoints. Sometimes, the imaging system 110 may capture and/or generate 3D product geometry data of the food products 112.

The captured 2D data 114A-N may be transmitted to the computer system 102 in block B (124). The 2D data 114A-N may be transmitted in real-time (e.g., as the 2D data is captured) or in batches, at predetermined time intervals (e.g., every 1 minute, every 5 minutes, every 10 minutes, every 15 minutes). One or more other criteria and/or triggers may be used to determine when to automatically transmit the 2D data 114A-N to the computer system 102.

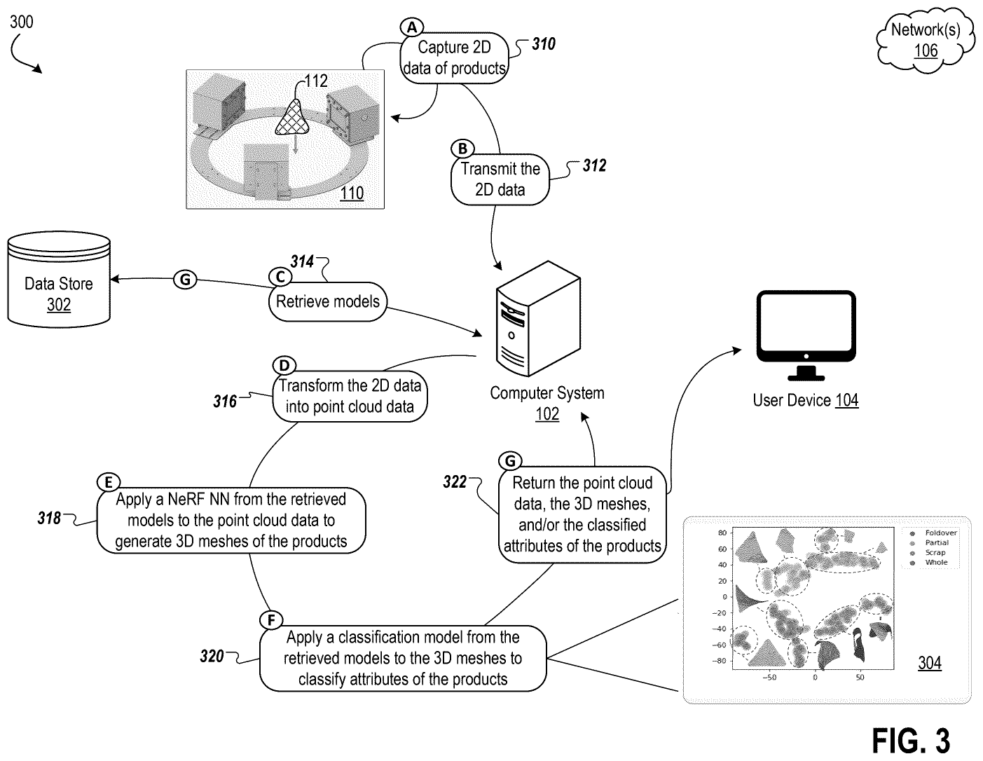

The computer system 102 may convert the 2D data 114A-N to 3D mesh data 116 using a first model (block C, 126). In some implementations, the first model may include a Neural Radiance Field (NeRF) neural network (NN). In other words, the NeRF NN may be used to generate a 3D model of each of the food products 112 that are captured in the 2D data 114A-N, thereby allowing a full geometry and characteristics of each food product piece to be captured and rendered in 3D space. One or more other types of models, NNs, and/or AI may be used to perform the operations of block C (126). The 3D mesh data 116 may represent the food products 112 in 3D space. Accordingly, the 3D mesh data may be used to generate synthetic pieces of the food products 112 and/or simulate the food products 112 during processing and/or packaging processes, as described further below. Refer to FIG. 3 for further discussion about converting the 2D data 114A-N to the 3D mesh data 116.

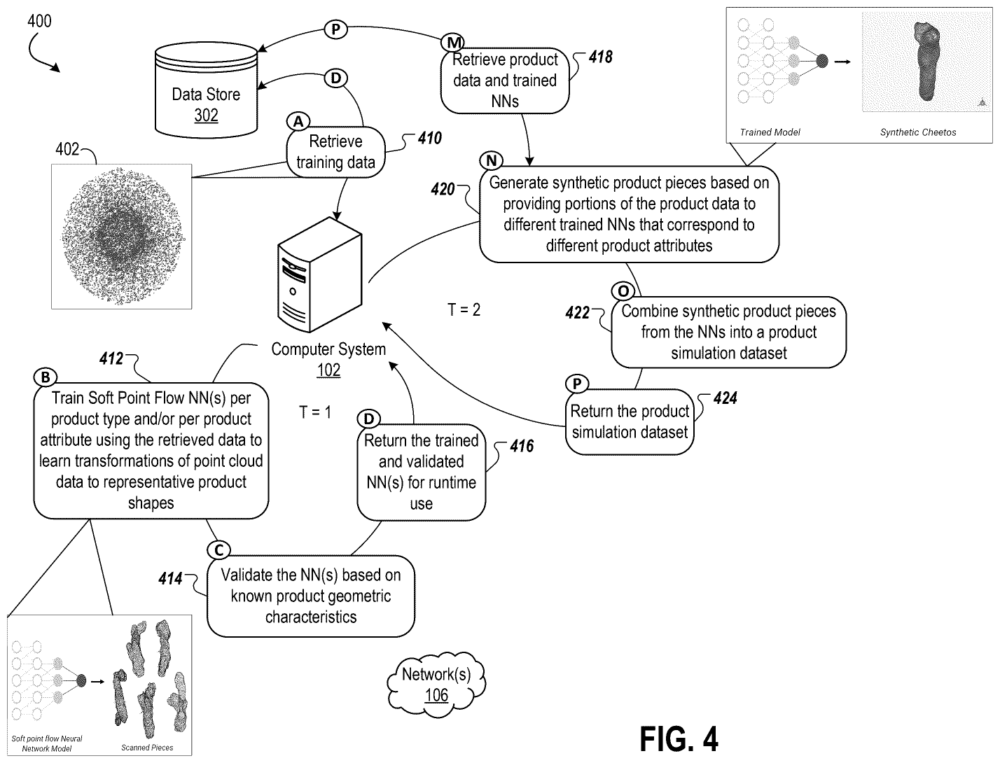

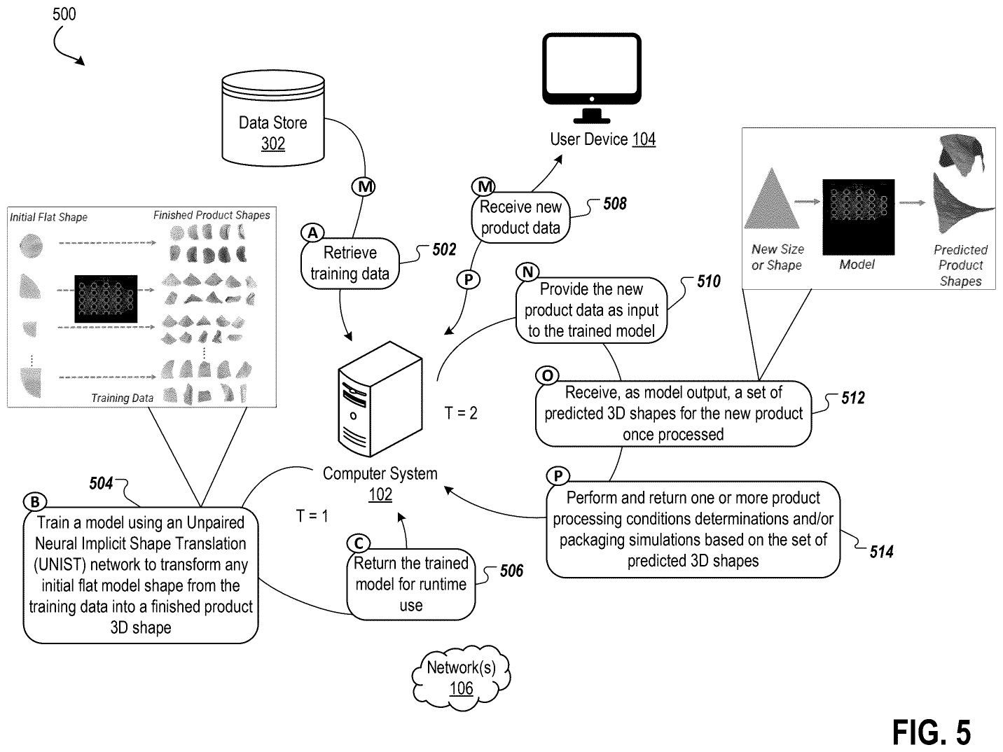

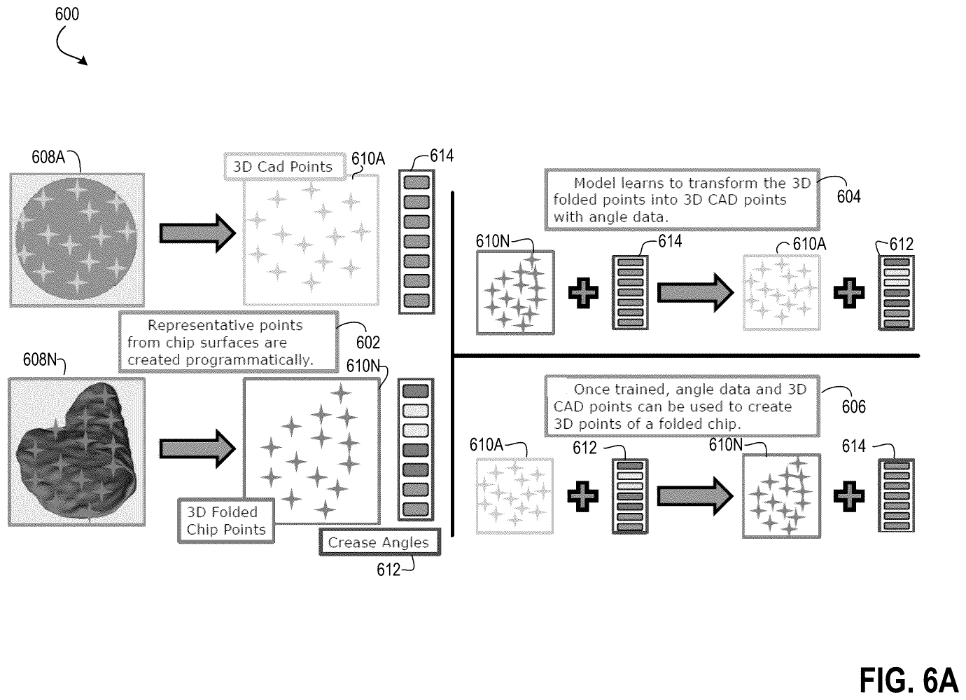

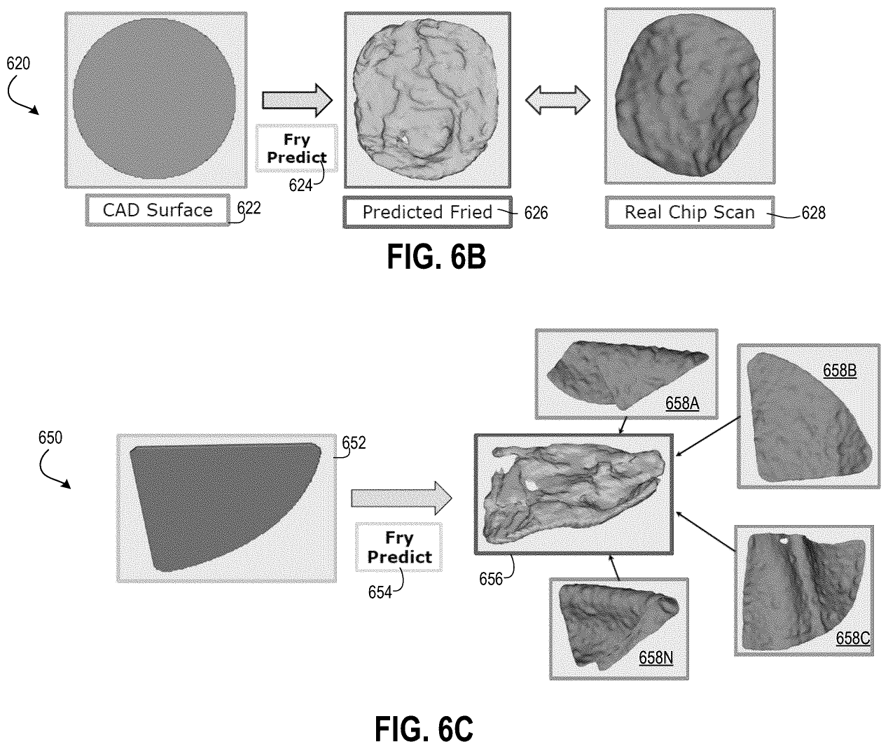

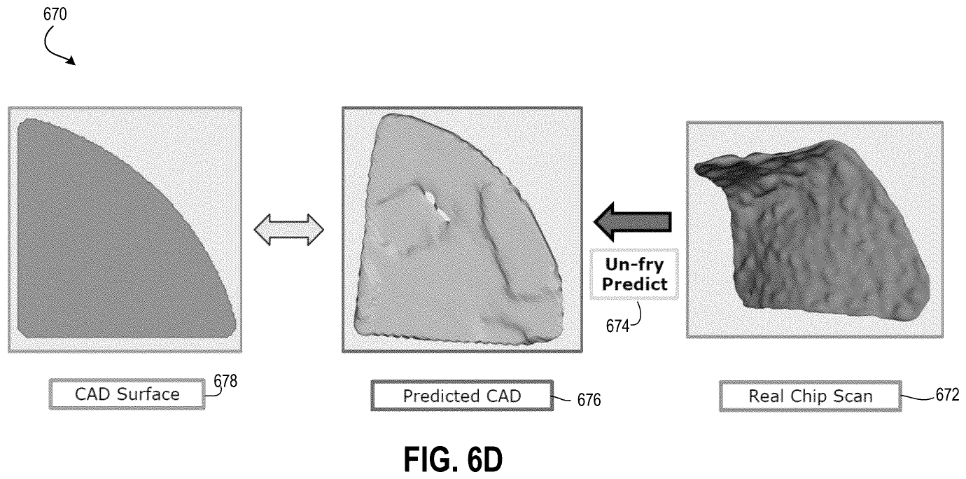

In block D (128), the computer system 102 may generate synthetic product pieces 118 based on applying one or more other models to the 3D mesh data 116. Sometimes, the models may include trained AI models. As described in reference to FIG. 4, the models, such as a Soft Point Flow Generative model and/or NN, may be trained and used to generate the synthetic product pieces 118 from the 3D mesh data 116 of the imaged food products 112 (e.g., the food product pieces). As another example and as described in reference to FIGS. 5 and 6, one or more other models, such as an Unpaired Neural Implicit Shape Translation (UNIST) model or network may be trained and used to generate the synthetic product pieces 118 from the 3D mesh data 116 of new or soon-to-be-created food products (e.g., food products in a virtual development phase). One or more other synthetic models and/or generative models, including but not limited to physics-based models, may be trained and used by the computer system 102 to generate a robust dataset of the synthetic product pieces 118.

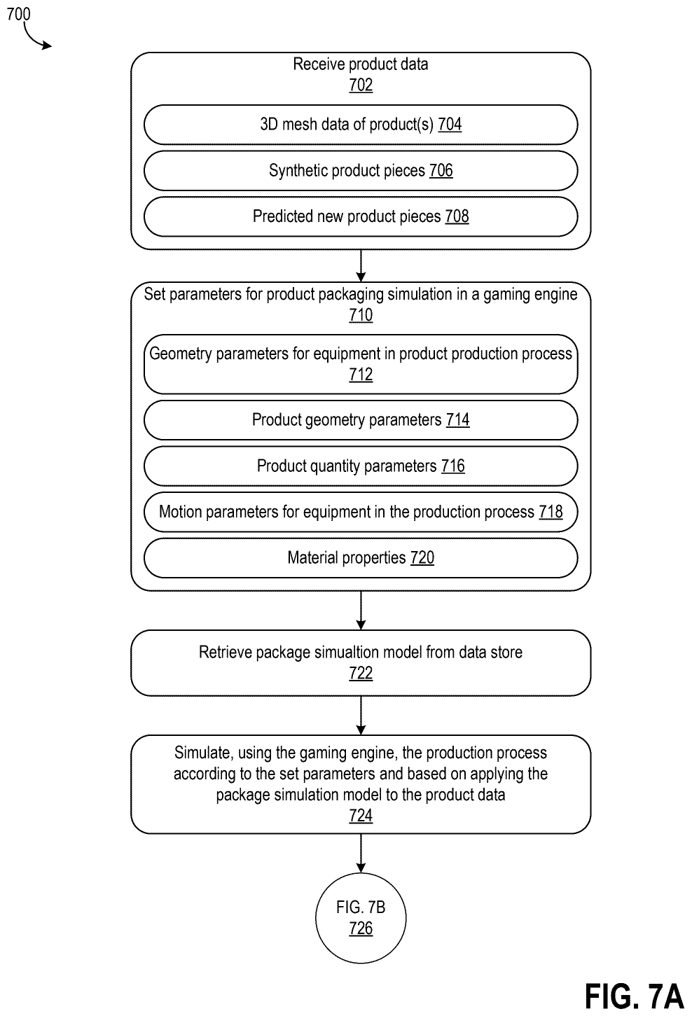

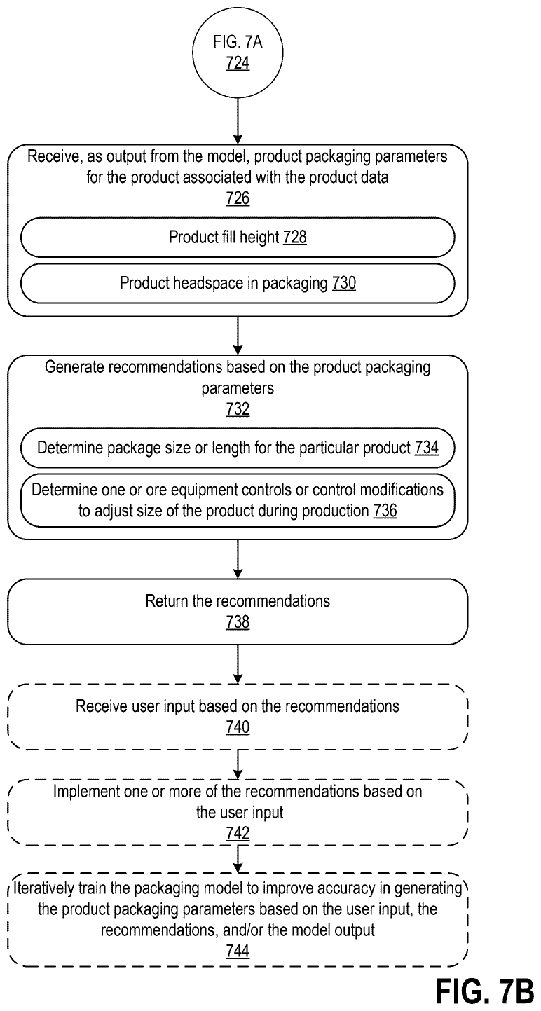

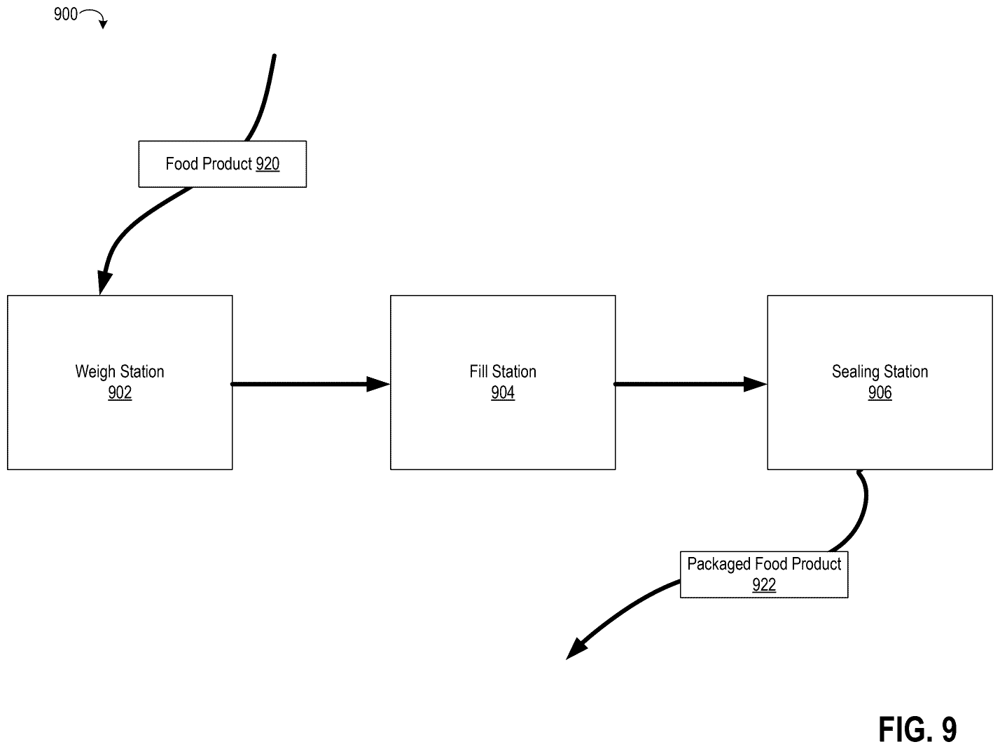

The computer system 102 may simulate at least product packaging parameters based on modeling at least the synthetic product pieces 118 (block E, 130). The simulation may be performed in a gaming engine or other type of simulation engine, as described herein (block E, 130). Simulations 120 may be performed using one or more machine learning models, such as a simulation packaging model, described further in reference to at least FIGS. 7A and 7B. The simulation(s) 120 may be performed to understand how the food products 112 may interact with and/or may be effected by processing operations and/or packaging operations in the facility 108. In some implementations, the simulation(s) 120 may be performed using one or more models that are trained to simulate or otherwise predict the processing of the food products 112, such as predicting a shape and/or geometry of the finished food products 112 as a result of performing various processing steps and/or as a result of various processing conditions to produce the finished food products 112 in the facility 108. Refer to FIG. 9 for further discussion about an illustrative example of the simulation(s) 120.

Sometimes, the simulation(s) 120 may be performed using a gaming engine or other type of simulation engine. As described herein, a gaming engine may provide for efficient, accurate, and speedy simulation of the food products 112 through processing and/or packaging operations in the facility 108. The gaming engine further may allow large numbers of simulations for many different products to be performed virtually to optimize processing, production, and/or packaging of the different products. Using the gaming engine to perform the simulation(s) 120, the computer system 102 may determine various packaging parameters such as, but not limited to, size of the to-be-formed bag, fill height and/or headspace of the food products 112 once packaged in bags. The packaging parameters may include differently-sized bags based on serving size. For example, the bag sizes may include small or individual size bags that may be used for single serving sizes or other small serving sizes to serve smaller food products. As another example, the bag sizes may include larger bag sizes, which may service larger serving sizes and/or larger food products. The model(s) used to perform the simulation(s) 120 may be trained to generate output of the various packaging parameters, such as indicating the fill height and/or headspace of the food products 112 once packaged.

In some implementations, the model(s) used to perform the simulation(s) 120 may be trained to generate output indicating shape, size, density, or other physical characteristics of the food products 112 to fit a particular bag type. This may be based on, as merely illustrative examples, consumer demand, need to use less packaging material so as to reduce waste, reduce environmental impact, and/or reduce other expenditures. In some implementations, the model(s) may be trained to generate output indicating a proper bag size for the particular type of food products 112, where the proper bag size may be defined using one or more criteria and/or end consumer preferences (e.g., consumers may prefer that the bags be as small as possible, and for purposes of preserving the food products 112, the facility 108 may seek to have a minimum predetermined headspace for the food products 112). Sometimes, the model(s) may be trained to generate output indicating a recommended bag size for the particular type of food products 112, based on the predicted fill height and/or headspace of the food products 112 once packaged.

Accordingly, the computer system 102 may generate and return output based on the simulation(s) 120 in block F (132). The computer system 102 may generate the output described above in reference to block D (130) (e.g., recommended bag size, predicted fill height, predicted headspace). The output may be transmitted to the user device 104 and presented in one or more graphical user interface (GUI) displays at the device 104. The relevant user at the user device 104 may then review the output and make one or more decisions based on the output.

In some implementations, the user may provide user input at the device 104 that, when executed by the computer system 102, causes the computer system 102 to automatically perform one or more operations according to the user input. For example, the user input may include instructions to simulate the food products 112 in one or more different bag sizes. Accordingly, the computer system 102 may simulate new product packaging parameters using the user input as a simulation parameter in block E (130). As another example, the user input may include instructions to execute a recommendation generated by the computer system 102 to adjust one or more processing conditions for the food products 112 (which may cause a change in the final shape of the food products 112). Accordingly, the computer system 102 may automatically execute the instructions to adjust the processing condition(s) in the processing facility 108, which may include controlling one or more processing apparatuses (such as an extruder) used in a processing cycle to affect a change in how the food products 112 are produced and processed in the facility 108. As yet another example, the user input may include indications of product bag sizes to use in a packaging process for the food products 112. Refer to FIGS. 7A and 7B for further discussion about generating and returning the output.

Any of the user input and/or the output generated by the computer system 102 may be fed back into the computer system 102 as part of an iterative feedback loop. The user input and/or the output may be used by the computer system 102 to continuously train and improve any of the models and/or NNs described herein. The continuous training and improvements may allow for the computer system 102 to more accurately generate output and recommendations for producing desired food products and desired packaging fill parameters for the food products. Increased accuracy in performing the operations described in reference to FIG. 1 may allow for improved virtual process development, opportunities to automatically modify the process (without requiring real-world tests of food product wastage), and/or improved control of production to achieve desired food products and their packaging parameters.

FIG. 2A illustrates the example imaging system 110 (e.g., imaging system) for imaging products, such as the food products 112. The imaging system 110 may be an automated camera system configured to smay or otherwise capture 2D data of any quantity of the food products 112 in different settings. The imaging system 110 may be configured to automatically capture the 2D data of the food products 112 as they pass through or in between components of the imaging system 110.

As described in reference to FIG. 1, for example, the imaging system 110 may be set up or arranged in the facility 108, as a near-line or on-line tool for imaging the food products 112 in production in the facility 108. The imaging system 110 may be used for in-line processing, such as in a food product frying process line in the facility 108. The imaging system 110 may additionally or alternatively be positioned near, on, or proximate a packaging apparatus in the facility 108 that may be configured to package the food products 112 during their production process. As an illustrative example of near-line processing, the imaging system 110 may be configured to receive samples of the food products 112 from their production process, where those samples may or may not be returned to the production process after the image capturing performed by the imaging system 110. Various other configurations are also possible. Sometimes, the facility 108 may include a plurality of imaging systems 110, where each of the plurality of imaging systems 110 may be positioned at different locations along the production line/process for the food products 112. As a result, the food products 112 may be imaged at various stages of production.

The imaging system 110 may include cameras 200A-N, a mounting apparatus 202, and/or other sensors 204A-N. The cameras 200A-N may include any combination of imaging sensors configured to capture 2D data of the food products 112, such as videos and/or images of the food products 112. For example, the cameras 200A-N may include any configuration of standard 2D imaging cameras, stereo vision cameras, multispectral cameras, hyperspectral cameras, infrared (IR) and/or thermal cameras, time of flight (ToF) cameras, line smay cameras, structured light cameras, X-ray imaging cameras, other light-based cameras, etc. The cameras 200A-N may be positioned and arranged on the mounting apparatus 202 to capture the 2D data of the food products 112 from different viewpoints and/or angles as the food products 112 pass through the mounting apparatus 202 (such as when the food products 112 are conveyed or move along conveyor belts, chutes, and/or tubes during a production process). As a result, the 2D data may represent the food products 112 from the different viewpoints and/or angles for generating accurate 3D meshes of the food products 112. Each of the cameras 200A-N may be positioned at a different viewpoint and/or angle. In some implementations, one or more of the cameras 200A-N may have overlapping viewpoints and/or angles to provide a full/complete imaging of the food products 112.

The cameras 200A-N may be equally spaced along a length of the mounting apparatus 202. In some implementations, the positioning of the cameras 200A-N on the mounting apparatus 202 may be based on a quantity of the cameras 200A-N in the imaging system 110 and/or an arrangement or placement of the imaging system 110 in the facility 108 of FIG. 1. The example imaging system 110 includes three cameras 200A-N. In some implementations, the imaging system 110 may have additional or fewer cameras. For example, the imaging system 110 may include 1 or 2 cameras. As another example, the camera system 110 may include more than three cameras (e.g., 4, 5, 6, 7, 8, 9) attached to the mounting apparatus 202. In some implementations, camera spacing may be adapted based on one or more factors, including but not limited to location(s) that the imaging system 110 is placed within a food product processing system, size of the cameras 200A-N, field of view, focus, and/or lens of the cameras 200A-N, the relevant food product(s) being processed and packaged, and/or a speed at which the food product(s) is being processed and packaged.

The mounting apparatus 202 may be configured to receive the cameras 200A-N and retain the imaging system 100 in relation to different components, equipment, and/or at various locations along the production line in the facility 108 of FIG. 1, or near the production line in the facility 108. In the example of FIG. 2A, the mounting apparatus 202 is circular-shaped, which may be advantageous for attaching the mounting apparatus 202 at or around a packaging tube in the production line. In other examples, the mounting apparatus 202 may be shaped differently (e.g., a straight line, a square, a rectangle, a generally oblong shape, a triangular shape) to attach to a desited location in the production line.

The other sensors 204A-N may be attached to any portion of the mounting apparatus 202. In some implementations, one or more of the sensors 204A-N may be attached to or otherwise be associated with a part of the cameras 200A-N. The other sensors 204A-N may be configured to generate sensor data that may also be used to perform the techniques described herein. The other sensors 204A-N may include, but are not limited to, color sensors, motion sensors, presence sensors, LiDAR sensors, sound sensors, and/or weight sensors. The 2D data and/or the sensor data may be processed using the disclosed technology to determine characteristics of the food products 112, such as their color, shape, breakage, and/or texture.

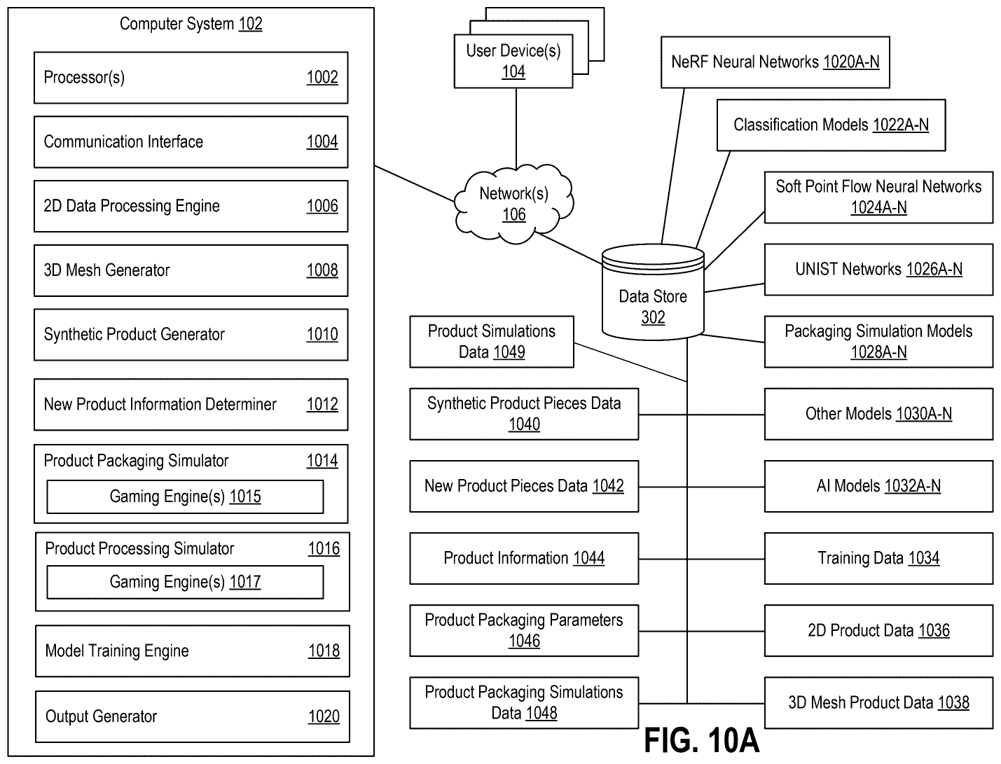

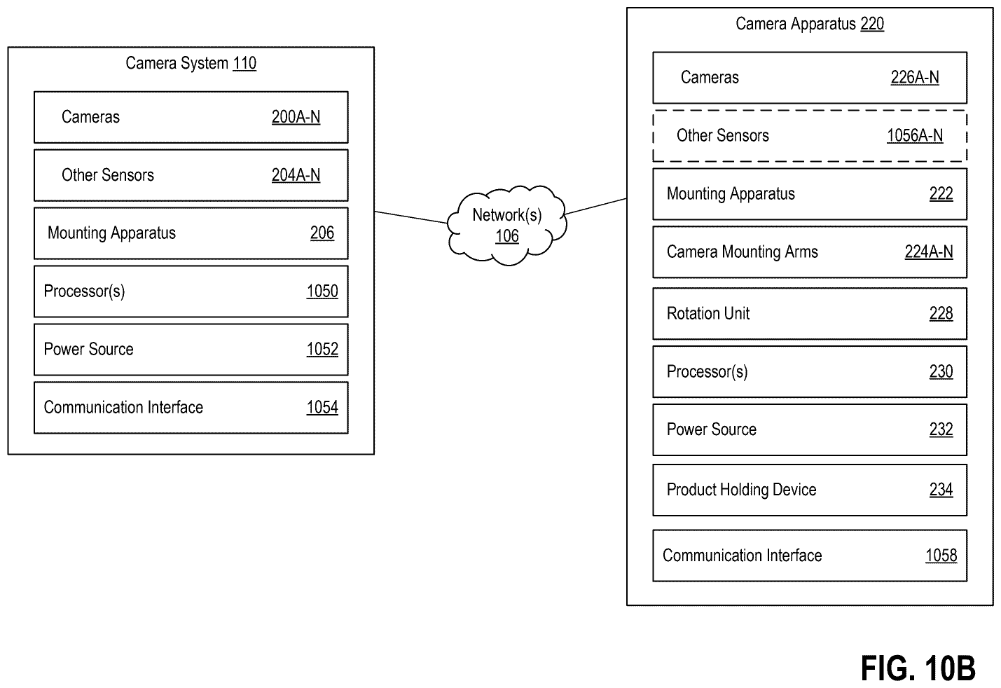

Refer to FIG. 10B for further discussion about the imaging system 110 and its components.

FIG. 2B illustrates an example imaging apparatus 220 for imaging products, such as a food product piece 221. The imaging apparatus 220 may similarly be used like the imaging system 110 for generating 2D data about the products. In comparison to the imaging system 110, the imaging apparatus 220 may be configured to be used for near-line processing. The imaging apparatus 220 may also be used to generate 2D data about individual pieces of products, such as the food product piece 221.

The imaging apparatus 220 may include a mounting apparatus 222, camera arms 224A-N, cameras 226A-N, a rotation unit 228, a processor 230, a power source 232, and a product holding device 234. The imaging apparatus 220 may include additional or fewer components, such as other sensors described in reference to FIG. 2B.

The mounting apparatus 222 may be configured to retain the imaging apparatus 220 in a desired location, such as near-line in the facility 108 of FIG. 1. The mounting apparatus 222 may be any type of structure, such as a vertical structure or pole. The mounting apparatus 222 may include the camera arms 224A-N, the cameras 226A-N, the rotation unit 228, the product holding device 234, the processor 230, and/or the power source 232.

The camera arms 224A-N may be configured to movably retain the cameras 226A-N in desired positioned and/or angles relative a position or location of the food product piece 221. In the example of FIG. 2B, the imaging apparatus 220 includes three camera arms 224A-N, each configured to movably maintain one of the cameras 226A-N in a desired location. The camera arms 224A-N may be positioned equidistant from each other along a length of the mounting apparatus 222. In some implementations, a first camera arm may be positioned at a top portion of the mounting apparatus 222, a second camera arm may be positioned at a middle portion of the mounting apparatus 222, and a third camera arm may be positioned at a bottom portion of the mounting apparatus 222. Various other configurations are also possible and may vary based on desired angles and/or viewpoints for the cameras 226A-N. One or more of the camera arms 224A-N may also have different lengths. The lengths of the camera arms 224A-N may vary based on a desired distance of the cameras 226A-N to the food product piece 221 and/or a desired angle and/or viewpoint of the cameras 226A-N.

The cameras 226A-N may be configured to capture 2D data, such as videos and/or images, of the food product piece 221 from their respective viewpoints and/or angles as the food product piece 221 is retained by the product holding device 234 and/or rotated in place by the rotation unit 228. The cameras 226A-N are similar to or the same as the cameras 220A-N. Refer to FIGS. 1, 2A, and 10B for further discussion about the cameras 226A-N.

The product holding device 234 may be configured to retain the food product piece 221 for imaging by the cameras 226A-N. The product holding device 234 may be positioned a predetermined distance away from the mounting apparatus 222, one or more of the camera arms 224A-N, and/or one or more of the cameras 226A-N. The product holding device 234 may be configured to retain or otherwise hold any type of food product piece that may be imaged using the imaging apparatus 220.

The rotation unit 228 may be configured to rotate the product holding device 234 having the food product piece 221 such that the cameras 226A-N may capture the 2D image data of an entirety of the food product piece 221 from different viewpoints and/or angles. The rotation unit 228 may be automatically controlled by the processor 230 to rotate at a speed that may correspond to a speed or intervals at which the cameras 226A-N are configured to capture the 2D image data. As an illustrative example, the rotation unit 228 may be rotated at a speed of 1 rotation per minute. As other examples, the rotation unit 228 may be rotated at faster speeds, such as 2rotations per minute, 5 rotations per minute, 10 rotations per minute, etc. In some implementations, the speed at which the rotation unit 228 moves/rotates may vary based on a size of the food product piece 221. For example, the larger the food product piece 221, the faster the rotation unit 228 may rotate so that the 2D image data may be captured of every surface/angle of the food product piece 221. On the other hand, the smaller the food product piece 221, the slower the rotation unit 228 may rotate so that the 2D image data may not be blurry.

The processor 230 may be configured to perform one or more controls and/or operations described herein. For example, the processor 230 may automatically instruct the rotation unit 228 to begin rotating the food product piece 221 upon detection (by a sensor such as a presence or weight sensor) of the food product piece 221 in the product mounting device 234. As another example, the processor 230 may automatically instruct the cameras 226A-N to capture the 2D image data of the food product piece 221 once the rotation unit 228 is moving. The processor 230 may control the cameras 226A-N to capture the 2D image data continuously and/or at predetermined time intervals. The processor 230 may also be configured to transmit, over a network, the 2D image data to one or more other systems, such as the computer system 102 described herein (refer to FIG. 1).

The power source 232 may be configured to provide power to one or more components of the imaging apparatus 220. For example, the power source 232 may provide power to the cameras 226A-N, the rotation unit 228, and/or the processor 230. The power source 232 may include a battery. The battery may be rechargeable. One or more other types of power sources 232 may be used, including but not limited to solar panels.

FIG. 2B provides an illustrative example setup of the imaging apparatus 220. Any of the components of the imaging apparatus 220 may be adjusted to achieve a different, desired setup for runtime use.

FIG. 3 is a conceptual diagram of a system 300 for determining product attributes based on processing image data of the products 112. In the system 300, the computer system 102 may communicate with the imaging system 110 (or the imaging apparatus 220 described in reference to FIG. 2B), the user device 104, and/or a data store 302 over the network(s) 106. The data store 302 may be any type of data storage system and/or apparatus, including but not limited to a data lake, a database, memory, local storage, and/or cloud-based storage.

The imaging system 110 may capture 2D data of the food products 112 in block A (310). Refer to at least block A (122) in FIG. 1 for further discussion.

The imaging system 110 may also transmit the 2D data to the computer system 102 in block B (312). Refer to at least block B (124) in FIG. 1 for further discussion.

The computer system 102 may retrieve one or more models from the data store 302 (block C, 314). The models may be used by the computer system 102 to process the 2D data and generate 3D models or other 3D data about the food products 112, as described herein.

Accordingly, the computer system 102 may transform the 2D data of the food products into point cloud data in block D (316). The transformation(s) may be performed using one or more of the retrieved models. For example, one of the retrieved models may include a deep learning neural network (NN), such as a convolutional neural network (CNN). The NN may be trained to predict depth in the 2D data and generate point cloud representations from the inputted data. For example, the CNN may be trained to receive one or more 2D images as input and output a corresponding depth map where each pixel in the depth map encodes an estimated distance from the imaging system 110. The CNN may be trained with 2D image data that is labeled with corresponding ground truth depth maps and other depth-related data. A relevant user and/or the computer system 102 may label the 2D image data with such depth-related data. Once the CNN generates a depth map based on processing the 2D image data, a 3D point cloud representation may be generated (e.g., the point cloud data). Camera parameters (e.g., calibration information) may be used by the computer system 102 to automatically convert each pixel in the depth map to a 3D point in a coordinate system corresponding to that of the imaging system 110. Moreover, for each pixel in the 2D image data with a depth value, the computer system 102 may automatically compute the 3D coordinates using the camera information and depth information described herein. In some implementations, the computer system 102 may perform one or more post-processing techniques to refine the point cloud data, such as to reduce noise, remove outliers, or otherwise smooth the point cloud data.

The computer system 102 may then apply a NeRF NN, from the retrieved models, to the point cloud data to generate 3D meshes of the food products 112 (block E, 318). The 3D meshes of the food products 112 may include 3D models of the food products 112. The computer system 102 may generate a 3D mesh or 3D model for every food product that is imaged by the imaging system 110.

The NeRF NN is configured to represent the food products 112 or other products as continuous 3D functions. Such functions may map 3D coordinates and a viewing direction to color values, density (e.g., opacity) values, geometry, and/or other parameters corresponding to the food products 112 or other products. The NeRF NN may be trained by the computer system 102 using a collection of images of the food products 112 and other food products from different viewpoints or angles. During training, the NeRF NN learns to optimize its parameters (e.g., neural network weights) such that the NN may render images that match the input images from different viewpoints or angles.

As a result of the training, the NeRF NN may learn to model the appearance, shape, and/or geometry of the particular food products 112 or other products, such as new or soon-to-be-created food products. For example, the NeRF NN may render new views of the food products 112 or other products. Given a new viewpoint or angle, the NeRF NN may evaluate a learned food production function to generate synthesized images of the food products 112 or other products that may be seen from the new viewpoint or angle.

Advantageously, the NeRF NN may produce highly realistic images or other renderings of the food products 112 or other products with complex lighting effects and detailed textures. This NN may also be used to generate new views of the food products 112 or other products from viewpoints or angle that may not have been captured in the images using for training the NN. Moreover, unlike traditional surface-based methods that may require explicit mesh representations, this NN may represent the food products 112 volumetrically, allowing for accurate handling of complex geometries and occlusions.

Once the 3D meshes of the food products 112 are generated, the computer system 102 may apply a classification model, from the retrieved models, to the 3D meshes to classify attributes of the food products 112 (block F, 320). The classified attributes may be used in a variety of use cases. For example, the classified attributes may be used to automate testing that's currently done manually. The manual testing may include food product breakage tests, where an operator (e.g., a user) may sort the food product by hand into whole, broken, and scrap pieces. Automating this process with the classification of the food product attributes may increase speed and accuracy of such testing, as well as eliminate a need for manual labor to perform the testing. The classified attributes may also be used to evaluate new processes and determine whether the new processes may have positive or negative impacts on the resulting, final food product. The same testing and/or evaluations may be done for other defect-type attributes of the food products.

The classification model may be trained to classify the 3D meshes of the food products 112 according to a variety of attributes, including but not limited to fold over product pieces, partial product pieces, scrap product pieces, and/or whole product pieces. Graph 304 illustrates example classification or mapping of food product 112 attributes using the classification model. The classification model may be trained by the computer system 102 to identify and classify attributes that are unique or otherwise specific to a particular type of the food products 112. For example, chip food products may have different attributes than cracker food products, so the computer system 102 may train a classification model for the chip food products and another classification model for the cracker food products.

The classification model(s) may be any type of deep learning and/or machine learning or AI model, including but not limited to a logistic regression model, a decision tree, a random forest model or network, support vector machines (SVMs), and/or a NN. The classification model(s) may be trained to learn patterns and/or relationships in input data that may correspond to different attributes for the food products 112. The classification model(s) may be trained by the computer system 102 with 3D mesh data of the food products 112 that have been labeled with attributes that may correspond to specific classes or categories. The labeling may be performed by a relevant user and/or automatically by the computer system 102. Feature extraction techniques may be applied to the labeled data by the computer system 102 to represent the food products 112 as a set of features or attributes that represent the food products 112 characteristics. Such features may be numerical, categorical, and/or derived from the 3D mesh data using feature recognition techniques and/or deep learning embeddings. During training, the labeled data may be provided to the classification model(s) by the computer system 102. Parameters of the model(s) may be automatically and iteratively adjusted during training to minimize error in predicted correct class attribute labels of the training, labeled data. Accordingly, the classification model(s) may be trained to learn patterns from the input features that may distinguish one class of attributes from another, as shown by the graph 304. For example, the model(s) may learn that certain combinations of features (e.g., color, shape, size) may be associated with specific types of the food products 112 (e.g., full or whole food product, broken food product, a portion of a food product piece).

The computer system 102 may return the point cloud data, the 3D meshes of the food products 112, and/or the classified attributes of the food products 112 in block G (322). The computer system 102 may transmit such information/data to the data store 302 for storage and later use. The computer system 102 may transmit the information/data to the user device 104 for presentation in one or more GUIs as described herein. The computer system 102 may feed the information/data back into the computer system 102 for purposes of iteratively improving or otherwise training the models described herein. The computer system 102 may also use the information/data for performing one or more other operations described herein (such as generating synthetic data of the food products 112).

FIG. 4 is a conceptual diagram of a system 400 for training a model to generate synthetic product data and using the trained model during runtime. When a physical product, such as the food products 112 described herein exists or otherwise has been created, the system 400 may leverage point cloud data, 3D mesh data, and/or attribute data for the product to generate synthetic data models or synthetic data sets of the product. Refer to FIG. 3 for further discussion about generating the point cloud data, the 3D mesh data, and/or the attribute data for the product. When a product is new or soon-to-be-created, the techniques described in reference to FIGS. 5 and 6 may be performed to generate synthetic data models or synthetic data sets of the new product.

By generating the synthetic data models or data sets of a particular product, the disclosed technology may create a large number of different shapes, sizes, and/or geometries that the particular product may assume as a result of producing the product, e.g., processing conditions or parameters. Such synthetic data may then be used with the disclosed technology to simulate production and/or packaging of the particular product in a facility, such as the facility 108 of FIG. 1.

In the system 400, the computer system 102 may communicate over the network(s) 106 with at least the data store 302. The computer system 102 may retrieve training data 402 from the data store 302 in block A (410). The training data 402 may include any of point cloud data for a particular food product, 3D models or mesh data of the food product, and/or attributes information of the food product. The training data 402 may be generated using modeling techniques by the computer system 102 as described in the system 300 of FIG. 3.

Using the training data 402, the computer system 102 may train one or more models to generate synthetic data for the food product. For example, the computer system 102 may train a Soft Point Flow NN per product type and/or per product attribute using the retrieved training data (block B, 412). The NN may be trained to learn transformations of the point cloud data, for example, to representative shapes of the particular food product. The representative shapes may include but are not limited to length, volume, thickness, texture, roughness, and/or general shape. The NN may be trained to generate synthetic versions of the particular food product for runtime simulations. This type of NN may implement soft attention techniques, which includes computing attention weights across all elements of the input data to allow for the NN to dynamically focus on different aspects of the input data.

Instead of the Soft Point Flow NN, the computer system 102 may train any other type of generative and/or synthetic generative model. For example, the computer system 102 may train generative adversarial networks (GANs), discriminator models, or a combination thereof to generate the synthetic data for the food product. As another example, the computer system 102 may train Variational autoencoders (VAEs) and/or Flow-based generative models. Regardless of a type of model that is trained, the computer system 102 may generate, using the trained model, infinite numbers of product pieces having similar characteristics to the real product represented by the retrieved training data.

As described herein, each product type and/or attribute of the particular food product may have its own trained synthetic generative model. The training and use of many synthetic generative models may also vary based on defects that are known or expected for the particular food product and/or the different attributes that are known or expected for the particular food product. As merely illustrative examples, different types of a particular food product (e.g., different types of chips) may have respective trained synthetic generative models, differently shaped or colored products of a same food product may have respective trained synthetic models, etc. The model(s) may be trained based on the attributes that are recognized and learned by the classification model(s) described and used in the system 300 of FIG. 3 and/or based on desired or preferred attributes for the food product(s).

Once the Soft Point Flow NN(s) or other synthetic generative models are trained, the computer system 102 may validate the NN(s) based on known product geometric characteristics (block C, 414). The product geometric characteristics may include attributes that were identified by the computer system 102 using the classification model(s) described in the system 300 of FIG. 3. Such characteristics may include but are not limited to length, volume, thickness, roughness, texture, breakage, or other attributes escribed herein. The validation process may be performed in block C (414) until the NN(s) are learning the transformations of the point cloud data to the representative product shapes by at least a threshold level of accuracy or confidence.

Once the validation process is complete, the computer system 102 may return the trained and validated NNs for runtime use in block D (415). Returning the NNs may include storing the NNs in the data store 302 for further retrieval and use (e.g., during a runtime phase). Returning the NNs may include locally storing the NNs at the computer system 102 for easy and quick access and retrieval (e.g., during the runtime phase).

Blocks A (410), B (412), C (414), and D (416) may be performed at a first time, T=1. The first time may correspond to a training or pre-runtime phase.

At a second time, T=2, the computer system 102 may retrieve product data and the trained NNs from the data store 302 (block M, 418). The product data may include any of the data described in reference to the system 300 of FIG. 3, including but not limited to point cloud data of the particular product, 3D models or mesh data of the particular product, and/or attribute information/data for the particular product. In some implementations, one or more of the retrieved product data may be the same as the training data retrieved in block A (410).

In block N (420), the computer system 102 may generate synthetic product pieces for the particular product based on providing portions of the product data to different trained NNs that may correspond to different product attributes. As described above, the computer system 102 may train a model per product type and/or per attribute of the product type. Sometimes, the computer system 102 may run each of the models that were generated for the particular product and then combine outputs from each of the models in a dataset. Each of the models may generate synthetic product pieces as output, as described herein.

Accordingly, the computer system 102 may combine the synthetic product pieces that were generated by the NNs into a product simulation dataset in block O (422). Sometimes, the computer system 102 may apply one or more weights, rules, and/or criteria to the product simulation dataset to generate a subset of data for product simulations. As a merely illustrative example, the computer system 102 may look for a predetermined percentage of each product attribute type in the product simulation dataset to be extracted and added to the subset of data. The subset of data may then be made up of a balanced collection of data representing the different product attributes so that no single product attribute skews simulation results. In some implementations, the computer system 102 may look for different predetermined percentages of each product attribute so that certain product attributes are more represented than others for the product simulations.

In block P (424), the computer system 102 may return the product simulation dataset, or the subset of data. Returning the dataset (or the subset) may include storing the dataset in the data store 302 for future retrieval and use. Returning the dataset may additionally or alternatively include locally maintaining the dataset at the computer system 102 so that the computer system 102 may perform the simulations with the dataset (refer to at least FIGS. 7A and 7B for further discussion). The computer system 102 may also feed the dataset back into the computer system 102 in an iterative feedback loop to provide continuous training of any one or more of the models described throughout this disclosure.

Blocks A (410), B (412), C (414), and D (416) may be performed at the first time, T =1. Blocks M (418), N (420), O (422), and P (424) may be performed at the second time, T =2. The first time may be before the second time. In some implementations, the first time may overlap with at least a portion of the second time and/or the first and second time may be the same time. In the example of FIG. 4, the first time represents a training phase or pre-runtime phase and the second time represents a runtime phase or post-training phase.

FIG. 5 is a conceptual diagram of a system 500 for training a model to predict new product characteristics, such as shape, and using the trained model during runtime. The system 500 may be used when food products are new or not yet created or existing. By predicting characteristics of the new products, the system 500 may determine preferred product production operations, conditions, and/or packaging to achieve a desired outcome (e.g., a desired shape of the new products, a desired packaging size for the new products).

In the system 500, the computer system 102 may communicate over the network(s) 106 with the data store 302 and/or the user device 104. The computer system 102 may retrieve training data from the data store 302 in block A (502). The training data may include, for example, 2D image data of the food products in their initial shape (e.g., initial flat shape before they are processed into a final product shape), point cloud data of the food products in their initial shape, and/or 3D models or mesh data of the food products in their initial shape. Accordingly, the training data may include a collection of pre-processed food product pieces. Some of the training data may include a collection of finished product pieces, in some implementations. In some implementations, the training data may include other information about the food products, such as processing attributes, processing conditions, and/or packaging parameters for the particular food product. Any of this other information may be initially generated by a relevant user at the user device 104 and provided to the computer system 102. Any of this information may be automatically generated by the computer system 102, such as based on previous or other processing and/or packaging information for other food products (e.g., known food products, similar food products).

At time T=1, the computer system 102 may train a model using a UNIST network to transform an initial flat model shape from the training data into a finished product 3D shape (block B, 504). The UNIST network may be used to learn transformations of the pre-processed food products to the post-processed finished food products. The UNIST network may also be used with the trained model to then predict shapes, geometries, and other attributes of the food products, such as new or soon-to-be-created food products.

Advantageously, the UNIST network allows for determining shape translations between different food products without requiring paired training data. In other words, the UNIST network structure may be unpaired, meaning it does not have a 1:1 correspondence of pre to post processed food product surfaces/shapes. Because the UNIST network is unpaired, it advantageously is more flexible and applicable to a wide range of datasets for different food products. The UNIST network may learn a mapping or transformation that converts 3D shapes of the food products from one set of shapes (e.g., pre-processed) to another set of shapes (e.g., post-processed). This may include modifying an appearance or properties of the food product shapes while preserving their underlying structure. The UNIST network may leverage GAN architectures to generate realistic shapes (e.g., with a generator model) and discriminate between real and generated shapes (e.g., with a discriminator model). The UNIST network may also leverage implicit neural representations (e.g., NNs that output signed distance functions) to encode and/or manipulate shapes, thereby offering improved flexibility and scalability to handle many and/or complex food product geometries.

The model (or models) may be trained to predict effects of processing on a pre-processed product shape and then predict a final product shape resulting from the processing. Such model output may be used by the computer system 102 to determine proper or preferred processing conditions to achieve a desired final shape (or other attributes) for the food product(s). The model output may additionally or alternatively be used to simulate not only processing of the food product, but also packaging of the food product, as described further herein.

During training, the model may be trained to learn the transformations that occur between the pre-processed food product pieces in the training data and the finished product pieces in the training data. The resulting trained model may then predict shapes of other finished food products based only on data of the pre-processed food products that are received during runtime. Accordingly, the model may be trained to predict future product shapes based on previous learned transformations. The model may be trained to predict finished product shapes based on new or different starting product shapes. The model may additionally or alternatively be trained to predict future product shapes as processing conditions are changed. The model that is trained by the system 500 may advantageously be used during runtime for the purposes of virtual product development, such as predicting and determining desired food product shape, size, and/or packaging. In some implementations, the computer system 102 may train one or more models to predict a future product shape based on transformation learnings from a UNIST network described herein. In yet some implementations, the computer system 102 may train a UNIST network to predict the future product shape(s).

The computer system 102 may return the trained model for runtime use in block C (506). Returning the trained model may include storing the model in the data store 302 for later retrieval and use. Returning the trained model may include locally maintaining the model at the computer system 102 for easy and quick deployment during runtime.

The blocks A (502), B (504), and C (506) may be performed at a first time, T=1. The first time may be a training phase or pre-runtime phase.

At a second time, T=2, the computer system 102 may receive new food product data from the user device 104 and/or the data store 302 (block M, 508). The new product data may be provided as user input at the user device 104 by a relevant user, such as a user developing or otherwise creating the new food product. The new product data may include product attributes, such as a desired shape, geometry, color, texture, roughness, etc. The new product data may include representations of the new product in an initial, pre-processed state. For example, the new product data may include 2D image data, point cloud data, and/or 3D model or mesh data of an initial, pre-processed representation/shape of the new product.

The computer system 102 may provide the new product data as input to the trained model during the second time, T=2 (block N, 510).

The computer system 102 may then receive, as model output, a set of predicted 3D shapes for the new product once the new product would be processed (block O, 512). In other words, the set of predicted 3D shapes for the new product may represent possible shapes of the new product once processed or otherwise created.

The computer system 102 may perform and return one or more product processing conditions determinations and/or packaging simulations based on the set of predicted 3D shapes for the new product (block P, 514). For example, the computer system 102 may apply one or more rules and/or criteria to the set of predicted 3D shapes to determine whether and how to adjust the processing conditions to achieve a desired product shape or other desired product attributes (e.g., the new product data received in block M, 508). As another example, the computer system 102 may provide the set of predicted 3D shapes to a simulation model (refer to FIGS. 7A and 7B for further discussion) to determine preferred packaging for the new product that may also achieve desired packaging parameters (e.g., consumer-preferred packaging size, appearance of the packaging on shelves or other retail displays).

Returning the determinations and/or packaging simulations may include generating related output and transmitting the output to the user device 104. The user device 104 may then present the output in one or more GUIs for the relevant user. The user may use the output to determine modifications to the development, processing, and/or packaging of the new product. In some implementations, the user device 104 may receive user input that, when executed by the computer system 102, causes automatic control and/or modification of equipment or components used in the development, processing, and/or packaging of the new product.

Returning the determinations and/or packaging simulations may include feeding such determinations and/or simulations back into the computer system 102 to iteratively train and improve any of the models described herein. In some implementations, the user input described above may also be provided back into the computer system 102 as part of a feedback loop to iteratively train and improve upon the model(s).

Blocks A (502), B (504), and C (506) may be performed at the first time, T=1. Blocks M (508), N (510), O (512), and P (514) may be performed at the second time, T=2. The first time may be before the second time. In some implementations, the first time may overlap with at least a portion of the second time and/or the first and second time may be the same time. In the example of FIG. 5, the first time represents a training phase or pre-runtime phase and the second time represents a runtime phase or post-training phase.

FIG. 6A illustrates a process 600 for training a model to predict new product characteristics. The process 600 is described from the perspective of predicting fold over characteristics of food products such as chips. The fold over characteristics are merely an illustrative use case and implementation of the process 600. The process 600 may also be performed to predict any other food product characteristics and/or attributes described herein.

The process 600 may be performed by the computer system 102 described herein. The process 600 may be performed by any other computer system, device, network of computing systems, servers, and/or cloud-based system. For illustrative purposes, the process 600 is described from the perspective of a computer system.

The computer system may receive training data 608A-N of a particular food product. In this illustrative example of the process 600, the computer system may receive training data 608A of a flat chip surface (e.g., 2D data, images) and training data 608N of a folded chip surface (e.g., 2D data, images). The computer system may programmatically generate representative 3D data 610A for the flat chip surface and 3D data 610N for the folded chip surface (block 602).

Once the 3D data 610A-N is generated, the computer system may identify attributes 614 of the flat chip surface and attributes 612 of the folded chip surface. The attributes 612 and/or 614 may be determined using techniques described herein, such as the classification model(s) in FIG. 3. The attributes 612 of the folded chip surface may include crease angles, where the chip may fold over, general shape, thickness, and/or product material type.

The computer system may then train a model that learns to transform the 3D data 610N of the folded chip surface into the 3D data 610A for the flat chip surface based on the attributes 612 of the folded chip surface (e.g., the crease angles, or other angles data) (block 604).

Once the model is trained, the attributes 612 of the folded chip surface (e.g., the crease angles or the other angles data) and the 3D data 610A for the flat chip surface may be used to create the 3D data 610N for the folded chip surface (block 606).

In some implementations, the computer system may train multiple models that each learn different characteristics of the food product(s). For example, the computer system may train a first model that may learn fold, curvature, and/or overall geometry of the food product. The computer system may train a second model that may learn texture and other details of the food product. The second model typically may be used in runtime after using the first model. Various other implementations and/or models may also be used with the disclosed techniques.

FIGS. 6B and 6C illustrate results 620 and 650, respectively, from using a model trained to predict how a product shape may change due to processing.

As shown by the results 620 in FIG. 6B, the model(s) described herein may learn how the product shape changes due to processing for small and/or simple shapes with minimum modes of curvature and/or folding. In this example, a computer system as described herein may receive a CAD surface data 622 or other 3D mesh data for a food product. In some implementations, instead of the CAD surface data 622, the computer system may receive image data of the food product. Here, the CAD surface data 622 may be a generally circular shape for a food product, such as a chip. The computer system may provide the CAD surface data 622 to a model as described herein to predict frying of the food product (block 624). The frying may be an operation performed during production or processing of the food product. The model may generate output indicating a predicted fried food product data 626. The predicted fried food product data 626 may include 3D mesh data or a model of what the food product may look like after undergoing the frying process during production/processing. The predicted fried food product data 626 may include shape, texture, thickness, color, and/or other characteristics/attributes that are predicted using the model and as a result of producing/processing the food product. The predicted fried food product data 626 may be compared to a real chip smay data 628, which indicates an accuracy of the model in predicting the final shape of the food product (e.g., chips) that start production/processing with a simple shape.

As shown by the results 650 in FIG. 6C, the model may need additional training so that the model may predict a reasonable shape of food products, such as chips, having many types of curvature (in comparison to the results 620 in FIG. 6B). The model prediction may be one to many, which means many different shapes of real fried/processed food products (e.g., chips) may be used to inform a final shape of a single predicted food product (e.g., a single chip). A single prediction by the model may try to incorporate folding and other characteristics of all potential real fried/processed food products that the model has been trained on.

Here, a computer system as described herein may receive CAD data 652 for a food product, such as a chip. The CAD data 652 may represent a generally irregular or less common shape for the food product, such as a relatively triangular shape. In some implementations, the computer system may receive image data of the food product instead of the CAD data 652. The computer system may provide the CAD data 652 as input to a model described herein to predict what the food product would look like after being fried/undergoing the respective processing (block 654). The model may generate a predicted product data 656 as output, indicating a predicted shape of the particular food product after being fried/processed. As shown by the results 650, the predicted product data 656 may be based on a variety of product shapes data 658A-N that the model has been trained with.

FIG. 6D illustrates example results 670 from using a model in reverse to identify what the model has learned about shape change during product processing. Such information may be used to predict a shape of a product to be produced, such as an initial shape before the product is processed (e.g., fried). In other words, using the model described herein in revise to un-fry or un-process a finished food product (e.g., a chip) demonstrates that the model learned something about shape change that may occur during processing (e.g., during frying). As shown by the results 670, the computer system described herein may receive a real chip smay data 672. The data 672 may include CAD data and/or image data described throughout this document. The data 672 may then be provided as input to the model described herein to perform an un-fry (or reverse-processing) prediction of the particular food product (e.g., a chip) (block 674). Output from the model may include a predicted CAD data 676 for the particular food product. The predicted CAD data 676 may be compared to a known CAD surface data 678 for the food product to indicate that the model has learned something about how the food product may change shape during processing (e.g., frying).

FIGS. 7A and 7B is a flowchart of a process 700 for determining packaging parameters for products. The packaging parameters may be determined by simulating a process for processing/producing the product(s) (e.g., food products) and packaging the product(s). The simulation may be performed by a model that was trained as described herein to perform the simulation. The simulation may further be performed or otherwise executed in a gaming engine or other simulation engine, which may allow for fast and accurate simulations. The process 700 may be performed to enable virtual development for existing products, new products, and/or soon-to-be created products.

The process 700 may be performed by the computer system 102 described herein. The process 700 may be performed by any other computer system, device, network of computing systems, servers, and/or cloud-based system. For illustrative purposes, the process 700 is described from the perspective of a computer system.

Referring to the process 700 in both FIGS. 7A and 7B, the computer system may receive product data in block 702. The product data may include but is not limited to 3D mesh data of the product(s) (block 704), synthetic product pieces (block 706), and/or predicted new product pieces (block 708). The 3D mesh data of the product(s) (block 704) may be generated by the computer system as described in reference to FIG. 3. The synthetic product pieces (block 706) may be generated by the computer system as described in reference to FIG. 4. The predicted new product pieces (block 708) may be generated by the computer system as described in reference to FIGS. 5 and 6.

The computer system may set one or more parameters for a packaging simulation in a gaming engine or other simulation engine in block 710. The parameters may include but are not limited to geometry parameters for equipment in a product production process (block 712), product geometry parameters (block 714), product quantity parameters (block 716), motion parameters for equipment in the production process (block 718) and/or material properties (block 720). The gaming engine may require the parameters to be set such that the simulation may mimic an actual, real-world production and packaging of the particular product(s).

For example, the geometry parameters for the equipment in the product production process (block 712) may include angle of repose of the product(s) on a surface in a facility along the production line, a slide angle of another surface in the facility along the production line, and/or film maytilever and/or loop information (e.g., how packaging material drapes over one or more equipment portions or pieces in the production line) associated with the production line. By setting these parameters, the simulation may accurately represent a real-world setup of the production line for the particular product(s). As another example, the product geometry parameters (block 714) may include information about expected shapes of individual product pieces, which may be derived from the 3D mesh data of the product(s) (block 704), the synthetic product pieces (block 706), and/or the predicted new product pieces (block 708). The product quantity parameters (block 716) may also be set to indicate how many product pieces will be added to the simulation and/or how many product pieces would be expected to be moving along the production line. As yet another example, the motion parameters for the equipment (block 718) may include information (such as speed information) about how the product(s) would likely move and/or in which directions the product(s) would move on conveyors or other equipment in the production line. As another example, the material properties (block 720) may be set to indicate types of materials being used in the production line, whether those materials relate to materials used to produce the product(s) and/or materials of the equipment being used in the production line. Other parameters may also be defined and set in blocks 710-720.

The computer system may retrieve a package simulation model (e.g., packaging model) from a data store in block 722. The package simulation model may be trained by the computer system to perform simulations of the product data in the gaming engine. The model may be trained to predict and identify effects of characteristics of the product(s) and/or the parameters on the production and packaging of the product(s). The model may also be trained to determine parameters, processing, and/or packaging conditions such as a dimensions of packaging material to be used for the product(s), a package fill, a headspace in the package as a result of the product(s), etc. For example, the package simulation model may be a physics-based model that solves physics-based equations for motion of the product(s) as it fills a package.

The computer system may then simulate, using the gaming engine, the production process according to the set parameters and based on applying the package simulation model to the product data (block 724). Simulating the production process may include simulating the particular product as it progresses through a process of development from initial shape to final shape. Simulating the production process may include simulating the particular product, once in its final shape, being packaged in the production line. Simulating the packaging of the product may include simulating packages being filled to a predetermined threshold level with the final product. Simulating the packaging of the product may include simulating packages being filled until a predetermined quantity or weight of the final product is filled inside the packages. Various other simulations may be performed. Refer to FIGS. 10A and 10B for further discussion about an illustrative simulation according to the product data and the set parameters.

In block 726, the computer system may receive, as output from the model, product packaging parameters for the product associated with the product data. For example, the output may include projected product fill height (block 728) and/or projected product headspace in a packaging (block 730). As described above, the product fill height in the package may be determined using a physics-based model. The physics-based model may be trained to perform a simulation where the model tracks position of the food products during each time interval in the packaging process. The physics-based model may measure a final predicted fill height from the simulation results. In yet some implementations, the computer system may run the simulation(s) and then apply a model (e.g., physics-based model) to output/results from the simulation(s) to determine the final predicted fill height.

The computer system may generate recommendations based on the product packaging parameters in block 732. For example, the computer system may determine a preferred package size and/or dimensions of packaging for the particular food product (block 734). The computer system may retrieve one or more rules and/or criteria from the data store for package size and/or dimension determinations and apply those rules/criteria to the product packaging parameters to determine the preferred size and/or dimension for the particular product. The one or more rules and/or criteria may indicate desired and/or preferred packaging dimensions for different types of products. As another example, the one or more rules and/or criteria may indicate predetermined thresholds and/or ratios of product-to-headspace of product-to-fill-height in packaging. Using the rules and/or criteria, the computer system may determine, for example, that a packaging for the particular food product that was simulated should be smaller in height, width, and/or volume by a predetermined amount in comparison to traditional or expected packaging for the particular food product or other food products (e.g., a class of similar type food products). The disclosed techniques may therefore be performed to determine proper packaging sizes to avoid wasting fill space (if the packaging is too large) but also to avoid product getting caught in a seal when sealing the packaging (if the packaging is too small).

As another example, the computer system may determine one or more equipment controls or control modifications to adjust size of the product during production (block 736). Similar to block 734, the computer system may retrieve one or more rules and/or criteria from the data store to be used to evaluate whether and how to modify the equipment controls and/or other controls during the production process of the product. For example, a preferred packaging size may be used, but if the finished product is expected to be too large to satisfy fill requirements for the preferred packaging size, the computer system may generate modified controls for an extruder in the production line to cause the product to be processed into a smaller size. The modified controls for the extruder may include but are not limited to controlling values such as screw speed, water addition, cutter speed, and/or food product attributes.

The computer system may return the recommendations in block 738. As described herein, returning the recommendations may include transmitting the recommendations to a user device (e.g., the user device 104) for presentation in one or more GUIs at the device. Returning the recommendations may include storing the recommendations in the data store, as another example.

Optionally, the computer system may receive user input based on the recommendations in block 740. The user input may indicate user selection of one or more of the recommendations for execution. The user input may indicate one or more parameters that the user desires to be simulated in the process 700. For example, the user input may indicate geometry parameters for the equipment, product geometry parameters, product quantity parameters, motion parameters, and/or material properties to be adjusted and/or used for performing a new packaging simulation in the gaming engine. The user input may indicate one or more parameters corresponding to a preferred shape of the product and/or a preferred packaging for the product, which may also be used by the computer system to perform a new packaging simulation in the gaming engine. One or more other user inputs may be received from the user device in block 740.

Optionally, the computer system may implement one or more of the recommendations based on the user input (block 742). For example, the computer system may automatically execute instructions to cause one or more of the equipment and/or the components in the production line to be adjusted according to the recommendations.

Optionally, the computer system may iteratively train the packaging model to improve accuracy in generating the product packaging parameters (block 744). The training may be based on the user input, the recommendations, and/or the model output.

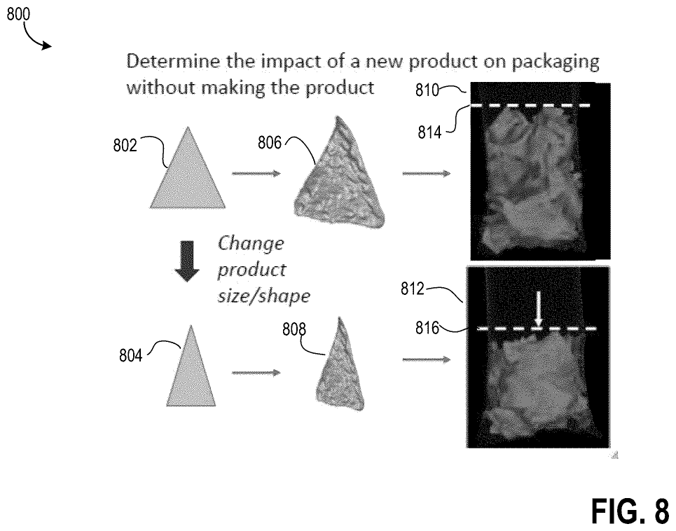

FIG. 8 illustrates a process 800 for determining an impact of a new product's characteristics on packing without physically producing the new product. In other words, the process 800 shown in FIG. 8 may be used to determine how soon-to-be-created products may take final shapes and how those final-shaped products may fit and/or fill packages. Advantageously, the process 800 may be performed as part of virtual process development and may not require the new products be produced/processed in order to understand how the new products would fit and fill packages. The process 800 may therefore be used to unobtrusively determine an impact of the new products on packaging without making the new products resulting in reduced product wastage. The process 800 is similar to techniques further described in reference to at least the system 500 of FIG. 5.

The process 800 may be performed by the computer system 102 described herein. The process 800 may be performed by any other computer system, device, network of computing systems, servers, and/or cloud-based system. For illustrative purposes, the process 800 is described from the perspective of a computer system.

In the process 800, the computer system may receive or otherwise generate data 802 and 804 for a new food product. The data 802 and/or 804 may include shape and/or size information that may be desired for the new food product. In some implementations, the data 802 and/or 804 may be generated by a relevant user and provided as user input at the user's computing device. In some implementations, the user input may include textual information describing the desired shape and/or size for the new food product. Upon receiving the user input from the user device, the computer system may generate the data 802 and/or 804 as product data for the process 800. Refer to at least blocks M (508) and N (510) in FIG. 5 for further discussion.

The computer system may then apply one or more machine learning and/or AI models to the data 802 and/or 804 to generate respective 3D shapes 806 and 808 of the new food product. The computer system may apply a UNIST network to the data 802 and 804, which may be configured to transform the initial flat model shapes of the data 802 and 804 into the respective 3D shapes 806 and 808. Refer to at least block O (512) in FIG. 5 for further discussion about using the model(s) and blocks B (504) and C (506) in FIG. 5 for further discussion about training the model(s).

Once the 3D shapes 806 and 808 of the new food product are generated, the computer system may provide the 3D shapes 806 and 808 as inputs to a packaging simulation model. The packaging simulation model may be trained to generate respective simulations 810 and 812 of the new food product using a gaming engine or other simulation engine, as described herein. Refer to at least block P (514) in FIG. 5 for further discussion about performing the simulations 810 and 812. Refer also to FIGS. 7A, 7B, 9A, and 9B for further discussion about running the simulations 810 and 812.

As shown in FIG. 8, the simulations 810 and 812 are run using a same packaging (e.g., bag) shape, size, width, height, and/or volume. However, because of a difference in the 3D shapes 806 and 808 of the new food product, the simulation 810 shows that the new food product having the 3D shape 806 would reach a higher fill line 814 in the packaging than the 3D shape 808 of the new food product. The simulation 812 shows that the new food product having the 3D shape 808 would reach a lower fill line 816 in the same packaging as in the simulation 810. Such information may be useful for the computer system to generate recommendations for modifying one or more processing operations to achieve a desired shape/size for the new food product and/or desired packaging parameters for the new food product (such as modifying the shape of the new food product so that the new food product may fit into a bag and reach a fill line that is between the fill lines 814 and 816 in the respective simulations 810 and 812. Such information may also be used by the relevant user to determine how to modify the processing operations and/or the packaging for the new food product.

FIG. 9 illustrates a block diagram of an example product packaging simulation 900. The simulation may be performed by the computer system 102 described herein, or any other type of computing system and/or cloud-based system. The simulation may be performed using a gaming engine or other simulation engine. A machine learning and/or AI model may further be used and trained to receive product data as inputs and generate a simulation of processing and/or packaging a product associated with the product data and according to processing and packaging simulation parameters. Refer to at least the process 700 in FIGS. 7A and 7B for further discussion about performing the simulation.

In some implementations, the simulation 900 may be performed for an entire production line, from creating or processing pieces of the food product to packaging and sealing the pieces of the food product into packages (e.g., bags). Sometimes, the simulation 900 may be performed for one or more operations or steps in the production line. For example, the simulation 900 may be performed for packaging pieces of the food product 920, from a point in time at which the pieces of the food product 920 are created, released from storage containers, and passed through a bag forming apparatus chute into a packaging film/material. The example simulation 900 in FIG. 9 illustrates one embodiment of a packaging process for pieces of the food product. Although FIG. 9 is described with respect to a simulation, this is a non-limiting example. What is shown in FIG. 9 may also be performed in real-time, in a physical production line in a plant. Operations performed and described in FIG. 9 may be automated, modified, and/or controlled using the disclosed techniques in order to provide preferred packaging of food products that are produced in the plant.

Referring to FIG. 9, the simulation 900 may include a weigh station 902, a fill station 904, and a sealing station 906. Food product 920 may already be produced and routed through the production line (e.g., by conveyor belts or lanes, by chutes) to the weigh station 902. The weigh station 902 may include one or more buckets in which the food product 920 is loaded. Pieces of the food product 920 may be transported into individual weight buckets until a predetermined or desired weight is achieved in the respective weight bucket.

Once the buckets are filled, pieces of the food product 920 in one or more of the buckets may be dropped into a partially formed package at the fill station 904. For example, the pieces of the food product 920 may be dropped into the partially formed packaging via a funnel system. A computer system as described herein may determine from which one or more buckets to drop the pieces of food product 920 into the partially formed packaging to achieve a desired or threshold fill level and/or weight in the packaging. Accordingly, the buckets may be automatically controlled to drop the pieces of the food products 920 to fill a bottom of the partially formed packaging until the pieces of the food products 920 reach a predetermined fill height or weight in the packaging.

Once the predetermined fill height and/or weight is achieved, the packaging with the pieces of food product 920 may be sealed at a sealing station 906. Physical components of the sealing station 906 may be configured to seal the packaging and simultaneously or otherwise settle the pieces of the food product 920 within the packaging (e.g., by rotating the packaging or shaking the packaging). Sometimes, settling may occur at the fill station 904 (e.g., during or after the pieces of the food product 920 are dropped into the partial package) or at another location between the fill station 904 and the sealing station 906. Once the food product 920 settles in the packaging, sealing jaws of the sealing station 906 may be configured to seal the packaging, which may be directed elsewhere to be, for example, further packaged in, for example cartons or containers for delivery.

FIGS. 10A and 10B are system diagrams illustrating system components that may be used to perform the disclosed techniques.

Referring to FIG. 10A, the computer system 102, the user device(s) 104, and the data store 302 may communicate (e.g., wired, wirelessly) with each other via the network(s) 106. Refer to at least FIG. 1 for further discussion about the user device(s) 104. Refer to at least FIG. 3 for further discussion about the data store 302.

The computer system 102 may include processor(s) 1000, a communication interface 1004, a 2D data processing engine 1006, a 3D mesh generator 1008, a synthetic product generator 1010, a new product information determiner 1012, a product packaging simulator 1014, a product processing simulator 1016, a model training engine 1018, and/or an output generator 1020. In brief, the processor(s) 1000 may be configured to store instructions that, when executed by the processor(s) 1000, causes the computer system 102 to perform any of the techniques described herein. The communication interface 1004 may be configured to provide communication between and amongst components of the computer system 102 and other system components described in reference to FIGS. 10A and 10B.

The 2D data processing engine 1006 may be configured to receive 2D product data 1036 of food products and process that data 1036 to generate point cloud data of the food products. The 2D product data 1036 may be generated by and received from the imaging system 110 and/or the imaging apparatus 220. The 2D product data 1036 may be retrieved by the engine 1006 from the data store 302, in some implementations. The 2D product data 1036 may include videos and/or images of the food products in-line or near-line during a production/processing and/or packaging lifecycle of the food products. Sometimes, the engine 1006 may retrieve one or more models 1030A-N and/or AI models 1032A-N from the data store 302 for use in processing the 2D product data 1036. Refer to at least block D (316) in FIG. 3 for further discussion about processing the 2D product data 1036.

The 3D mesh generator 1008 may be configured to receive the point cloud data from the 2D data processing engine 1006 and generate 3D mesh product data 1038 of the food products based on the receive point cloud data. For example, the generator 1008 may retrieve one or more NeRF NNs 1020A-N from the data store 302 and provide the point cloud data as input to the retrieved NNs 1020A-N. The NNs 1020A-N may process the point cloud data to generate the 3D mesh product data 1038 of the food products. Refer to at least block C (126) in FIG. 1 and block E (318) in FIG. 3 for further discussion about generating the 3D mesh product data 1038. In some implementations, the generator 1008 may also retrieve classification models 1022A-N from the data store 302 and provide the 3D mesh product data 1038 as input to the classification models 1022A-N. The classification models 1022A-N may generate output such as product information 1044 (e.g., attributes, shape, color, texture, roughness, size, fold, creases, breakage). Refer to at least block F (320) in FIG. 3 for further discussion.

The synthetic product generator 1010 may be configured to generate synthetic product pieces data 1040 based on processing one or more other data using models. For example, the generator 1010 may retrieve Soft Point Flow NNs 1024A-N, one or more of the other models 1030A-N, and/or one or more of the AI models 1032A-N from the data store 302. The generator 1010 may also retrieve or receive the 3D mesh product data 1038 and/or the product information 1044 for the particular food products from the data store 302 or other components of the computer system 102. Any of the retrieved/received data may be provided as input to the retrieved model(s) to generate output indicating the synthetic product pieces data 1040. Refer to at least block D (128) in FIG. 1 and the system 400 in FIG. 4 for further discussion about operations performed by the synthetic product generator 1010.

The new product information determiner 1012 may be configured to generate new product pieces data 1042 based on processing one or more other data using models described herein. For example, the determiner 1012 may retrieve UNIST networks 1026A-N, one or more of the other models 1030A-N, and/or one or more of the AI models 1032A-N from the data store 302. The determiner 1012 may also retrieve, from the data store 302, or receive, from the user device(s) 104, product information 1044 for new products to be produced, processed, and/or packaged. The product information 1044 may be provided as input to the retrieved model(s) to generate output indicating the new product pieces data 1042. The new product pieces data 1042 may include information such as a predicted or projected shape of the new product, an expected fill or other packaging information of the new product, etc. In some implementations, the determiner 1012 may also generate one or more recommendations for adjusting equipment and/or operations/conditions in a production line for the new product in order to achieve desired characteristics for the new food product. Refer to at least the system 500 in FIG. 5, the process 600 in FIG. 6A, and the process 800 in FIG. 8 for further discussion.

The product packaging simulator 1014 may be configured to run one or more simulations of a packaging process for different food products. The simulator 1014 may retrieve, from the data store 302, one or more packaging simulation models 1028A-N, one or more of the other models 1030A-N, and/or one or more of the AI models 1032A-N for use in performing the simulations. The simulator 1014 may also retrieve or otherwise receive, from the data store 302, components of the computer system 102, and/or the user device(s) 104, one or more of the 3D mesh product data 1038, the synthetic product pieces data 1040, the new product pieces data 1042, the product information 1044, and/or product packaging parameters 1046, which may be provided as inputs to the model(s). The simulator 1014 may be configured to run the simulations using the model(s) in one or more gaming engines 1015 or other types of simulation engines. As a result of running the simulations, the simulator 1014 may generate product packaging simulations data 1048. The data 1048 may include results from the simulation(s) and/or recommendations for improving or otherwise modifying the production and/or packaging of the different food products. Refer to at least block E (130) in FIG. 1, the process 700 in FIGS. 7A and 7B, and the simulation 900 in FIG. 9 for further discussion about running the simulation(s).

The product processing simulator 1016 may be configured to run one or more simulations of a production process for different food products. The simulator 1016 may retrieve, from the data store 302, one or more of the other models 1030A-N and/or one or more of the AI models 1032A-N for use in performing the simulations. In some implementations, the simulator 1016 may retrieve one or more of the packaging simulation models 1028A-N, which may be trained to perform simulations of processing and packaging the different food products. The simulator 1016 may also retrieve or otherwise receive, from the data store 302, components of the computer system 102, and/or the user device(s) 104, one or more of the 3D mesh product data 1038, the synthetic product pieces data 1040, the new product pieces data 1042, the product information 1044, product packaging parameters 1046, and/or the product packaging simulations data 1048, which may be provided as inputs to the model(s). The simulator 1016 may be configured to run the simulations using the model(s) in one or more gaming engines 1017. As a result of running the simulations, the simulator 1016 may generate product simulations data 1049. The data 1049 may include results from the simulation(s) and/or recommendations for improving or otherwise modifying the production and/or packaging of the different food products. Refer to at least block E (130) in FIG. 1, the process 700 in FIGS. 7A and 7B, and the simulation 900 in FIG. 9 for further discussion about running the simulation(s).

In some implementations, the product packaging simulator 1014 and the product processing simulator 1016 may be part of a same simulator. For example, the simulator may run a simulation using a gaming engine that simulates both product processing and packaging. As a result, the simulator may generate output indicating results from simulating both processes for the different food products. The simulator may also generate a combination of recommendations for modifying the processing operations, the packaging operations, or both.

The model training engine 1018 may be configured to train any of the models described herein. The engine 1018 may retrieve training data 1034 from the data store 302 and use the training data 1034 to train each of the models described herein, including but not limited to the NeRF NNs 1020A-N, the classification models 1022A-N, the Soft Point Flow NNs 1024A-N, the UNIST networks 1026A-N, the packaging simulation models 1028A-N, the other models 1030A-N, and/or the AI models 1032A-N. Refer to FIG. 3 for further discussion about training the NeRF NNs 1020A-N and the classification models 1022A-N. Refer to FIG. 4 for further discussion about training the Soft Point Flow NNs 1024A-N. Refer to FIGS. 5 and 6 for further discussion about training the UNIST networks 1026A-N. Refer to FIGS. 7A and 7B for further discussion about training the packaging simulation models 1028A-N.

The output generator 1020 may be configured to generate output to be presented in GUIs at one or more displays of the user device(s) 104. The generator 1020 may receive information from any of the components of the computer system 102 and generate the GUIs to visually present the information in an easy-to-understand format for users at the device(s) 104. In some implementations, the generator 1020 may receive output from models that are executed by the components of the computer system 102 and generate recommendations based on the received outputs. For example, the generator 1020 may generate recommendations to adjust operations and/or conditions in a production line and/or packaging process for one or more food products based on simulation results from the simulator 10104 and/or 1016. Refer to at least block F (132) in FIG. 1, block G (322) in FIG. 3, block M (508) in FIG. 5, and the process 700 in FIGS. 7A and 7B for further discussion about generating output.

Referring to FIG. 10B, the imaging system 110 and/or the imaging apparatus 220 may communicate (e.g., wired, wirelessly) via the network(s) 106 with each other and/or with other system components described in reference to FIG. 10A. For example, the imaging system 110 and/or the imaging apparatus 220 may communicate with the computer system 102, the data store 302, and/or even the user device(s) 104.

The imaging system 110 may include the cameras 200A-N, the other sensors 204A-N, the mounting apparatus 206, one or more processors 1050, a power source 1052, and/or a communication interface 1054. Refer to FIG. 1 and FIG. 2A for further discussion about the imaging system 110, the cameras 200A-N, the other sensors 204A-N, and the mounting apparatus 206. The processor(s) 1050 may be configured to maintain and execute instructions for performing operations and controls described herein. For example, the processor(s) 1050 may execute instructions that cause the cameras 200A-N to capture images (e.g., the 2D product data 1036) of food products as the food products pass or otherwise are proximate to the cameras 200A-N or the imaging system 110 more generally. The power source 1052 may be configured to provide power to one or more components of the imaging system 110, such as the cameras 200A-N, the other sensors 204A-N, the processor(s) 1050, and/or the communication interface 1054. The power source 1052 may be similar to the power source 232 described in reference to the imaging apparatus 220 in FIG. 2B. The communication interface 1054 may provide for communication between and amongst components of the imaging system 110 and other system components described in reference to FIGS. 10A and 10B.

The imaging apparatus 220 may include the cameras 226A-N, optional other sensors 1056A-N, the mounting apparatus 222, the camera mounting arms 224A-N, the rotation unit 228, the processor(s) 230, the power source 232, the product holding device 234, and/or a communication interface 1058. Refer to at least FIG. 2B for further discussion about the imaging apparatus 220, the cameras 226A-N, the mounting apparatus 222, the camera mounting arms 224A-N, the rotation unit 228, the processor(s) 230, the power source 232, and/or the product holding device 234. The other sensors 1056A-N may be optionally attached to the imaging apparatus 220, similarly to the cameras 226A-N. For example, one or more of the other sensors 1056A-N may be attached to the mounting apparatus 222, the camera mounting arms 224A-N, the rotation unit 228, and/or the product holding device 234. The other sensors 1056A-N may be similar to the other sensors 204A-N of the imaging system 110, described in further detail in reference to FIG. 2A. The communication interface 1058 may provide for communication between and amongst components of the imaging apparatus 220 and other system components described in reference to FIGS. 10A and 10B.

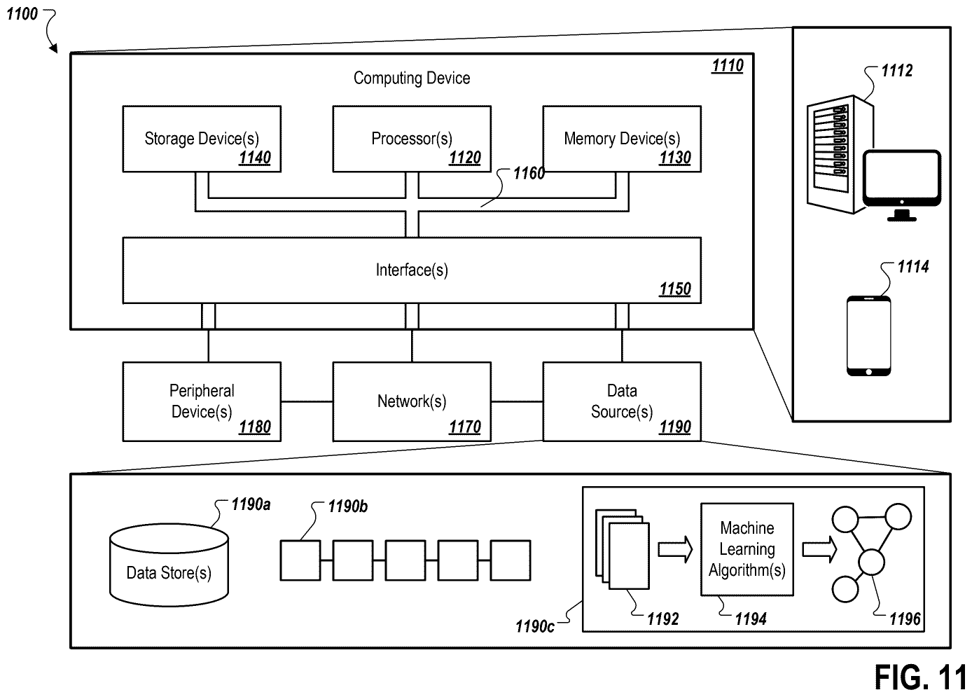

FIG. 11 is a schematic diagram that shows an example of a computing system 1100 that may be used to implement the techniques described herein. The computing system 1100 includes one or more computing devices (e.g., computing device 1110), which may be in wired and/or wireless communication with various peripheral device(s) 1180, data source(s) 1190, and/or other computing devices (e.g., over network(s) 1170). The computing device 1110 may represent various forms of stationary computers 1112 (e.g., workstations, kiosks, servers, mainframes, edge computing devices, quantum computers, etc.) and mobile computers 1114 (e.g., laptops, tablets, mobile phones, personal digital assistants, wearable devices, etc.). In some implementations, the computing device 1110 may be included in (and/or in communication with) various other sorts of devices, such as data collection devices (e.g., devices that are configured to collect data from a physical environment, such as microphones, cameras, smayners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) may include components of the computing device 1110, and an entire system may be made up of multiple devices communicating with each other. For example, the computing device 1110 may be part of a computing system that includes a network of computing devices, such as a cloud-based computing system, a computing system in an internal network, or a computing system in another sort of shared network. Processors of the computing device (1110) and other computing devices of a computing system may be optimized for different types of operations, secure computing tasks, etc. The components shown herein, and their functions, are meant to be examples, and are not meant to limit implementations of the technology described and/or claimed in this document.

The computing device 1110 includes processor(s) 1120, memory device(s) 1130, storage device(s) 1140, and interface(s) 1150. Each of the processor(s) 1120, the memory device(s) 1130, the storage device(s) 1140, and the interface(s) 1150 are interconnected using a system bus 1160. The processor(s) 1120 are capable of processing instructions for execution within the computing device 1110, and may include one or more single-threaded and/or multi-threaded processors. The processor(s) 1120 are capable of processing instructions stored in the memory device(s) 1130 and/or on the storage device(s) 1140. The memory device(s) 1130 may store data within the computing device 1110, and may include one or more computer-readable media, volatile memory units, and/or non-volatile memory units. The storage device(s) 1140 may provide mass storage for the computing device 1110, may include various computer-readable media (e.g., a floppy disk device, a hard disk device, a tape device, an optical disk device, a flash memory or other similar solid state memory device, or an array of devices, including devices in a storage area network or other configurations), and may provide date security/encryption capabilities.

The interface(s) 1150 may include various communications interfaces (e.g., USB, Near-Field Communication (NFC), Bluetooth, WiFi, Ethernet, wireless Ethernet, etc.) that may be coupled to the network(s) 1170, peripheral device(s) 1180, and/or data source(s) 1190 (e.g., through a communications port, a network adapter, etc.). Communication may be provided under various modes or protocols for wired and/or wireless communication. Such communication may occur, for example, through a transceiver using a radio-frequency. As another example, communication may occur using light (e.g., laser, infrared, etc.) to transmit data. As another example, short-range communication may occur, such as using Bluetooth, WiFi, or other such transceiver. In addition, a GPS (Global Positioning System) receiver module may provide location-related wireless data, which may be used as appropriate by device applications. The interface(s) 1150 may include a control interface that receives commands from an input device (e.g., operated by a user) and converts the commands for submission to the processors 1120. The interface(s) 1150 may include a display interface that includes circuitry for driving a display to present visual information to a user. The interface(s) 1150 may include an audio codec which may receive sound signals (e.g., spoken information from a user) and convert it to usable digital data. The audio codec may likewise generate audible sound, such as through an audio speaker. Such sound may include real-time voice communications, recorded sound (e.g., voice messages, music files, etc.), and/or sound generated by device applications.

The network(s) 1170 may include one or more wired and/or wireless communications networks, including various public and/or private networks. Examples of communication networks include a LAN (local area network), a WAN (wide area network), and/or the Internet. The communication networks may include a group of nodes (e.g., computing devices) that are configured to exchange data (e.g., analog messages, digital messages, etc.), through telecommunications links. The telecommunications links may use various techniques (e.g., circuit switching, message switching, packet switching, etc.) to send the data and other signals from an originating node to a destination node. In some implementations, the computing device 1110 may communicate with the peripheral device(s) 1180, the data source(s) 1190, and/or other computing devices over the network(s) 1170. In some implementations, the computing device 1110 may directly communicate with the peripheral device(s) 1180, the data source(s), and/or other computing devices.

The peripheral device(s) 1180 may provide input/output operations for the computing device 1110. Input devices (e.g., keyboards, pointing devices, touchscreens, microphones, cameras, smayners, sensors, etc.) may provide input to the computing device 1110 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) may provide output from the computing device 1110 (e.g., user-directed output and/or other output that results in actions being performed in a physical environment). Other kinds of devices may be used to provide for interactions between users and devices. For example, input from a user may be received in any form, including visual, auditory, or tactile input, and feedback provided to the user may be any form of sensory feedback (e.g., visual feedback, auditory feedback, or tactile feedback).

The data source(s) 1190 may provide data for use by the computing device 1110, and/or may maintain data that has been generated by the computing device 1110 and/or other devices (e.g., data collected from sensor devices, data aggregated from various different data repositories, etc.). In some implementations, one or more data sources may be hosted by the computing device 1110 (e.g., using the storage device(s) 1140). In some implementations, one or more data sources may be hosted by a different computing device. Data may be provided by the data source(s) 1190 in response to a request for data from the computing device 1110 and/or may be provided without such a request. For example, a pull technology may be used in which the provision of data is driven by device requests, and/or a push technology may be used in which the provision of data occurs as the data becomes available (e.g., real-time data streaming and/or notifications). Various sorts of data sources may be used to implement the techniques described herein, alone or in combination.

In some implementations, a data source may include one or more data store(s) 1190a. The database(s) may be provided by a single computing device or network (e.g., on a file system of a server device) or provided by multiple distributed computing devices or networks (e.g., hosted by a computer cluster, hosted in cloud storage, etc.). In some implementations, a database management system (DBMS) may be included to provide access to data contained in the database(s) (e.g., through the use of a query language and/or application programming interfaces (APIs)). The database(s), for example, may include relational databases, object databases, structured document databases, unstructured document databases, graph databases, and other appropriate types of databases.

In some implementations, a data source may include one or more blockchains 1190b. A blockchain may be a distributed ledger that includes blocks of records that are securely linked by cryptographic hashes. Each block of records includes a cryptographic hash of the previous block, and transaction data for transactions that occurred during a time period. The blockchain may be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain may maintain data quality (e.g., through data replication) and may improve data trust (e.g., by reducing or eliminating central data control).

In some implementations, a data source may include one or more machine learning systems 1190c. The machine learning system(s) 1190c, for example, may be used to analyze data from various sources (e.g., data provided by the computing device 1110, data from the data store(s) 1190a, data from the blockchain(s) 1190b, and/or data from other data sources), to identify patterns in the data, and to draw inferences from the data patterns. In general, training data 1192 may be provided to one or more machine learning algorithms 1194, and the machine learning algorithm(s) may generate a machine learning model 1196. Execution of the machine learning algorithm(s) may be performed by the computing device 1110, or another appropriate device. Various machine learning approaches may be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques may be employed, including but not limited to convolutional neural networks (CNNs), deep neural networks (DNNs), recurrent neural networks (RNNs), and other types of multi-layer neural networks.

Various implementations of the systems and techniques described herein may be realized in digital electronic circuitry, integrated circuitry, specially designed ASICs (application specific integrated circuits), computer hardware, firmware, software, and/or combinations thereof. A computer program product may be tangibly embodied in an information carrier (e.g., in a machine-readable storage device), for execution by a programmable processor. Various computer operations (e.g., methods described in this document) may be performed by a programmable processor executing a program of instructions to perform functions of the described implementations by operating on input data and generating output. The described features may be implemented in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, by a computer to perform a certain activity or bring about a certain result. A computer program may be written in any form of programming language, including compiled or interpreted languages, and may be deployed in any form, including as a stand-alone program or as a module, component, subroutine, or other unit suitable for use in a computing environment. A computer program product may be a computer-or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and may be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer may also include, or may be operatively coupled to communicate with, one or more mass storage devices for storing data files. Such devices may include magnetic disks (e.g., internal hard disks and/or removable disks), magneto-optical disks, and optical disks. Storage devices suitable for tangibly embodying computer program instructions and data may include all forms of non-volatile memory, including by way of example semiconductor memory devices, flash memory devices, magnetic disks (e.g., internal hard disks and removable disks), magneto-optical disks, and optical disks. The processor and the memory may be supplemented by, or incorporated in, ASICs (application-specific integrated circuits).

The systems and techniques described herein may be implemented in a computing system that includes a back end component (e.g., a data server), or that includes a middleware component (e.g., an application server), or that includes a front end component (e.g., a client computer having a graphical user interface or a Web browser through which a user may interact with an implementation of the systems and techniques described here), or any combination of such back end, middleware, or front end components. The components of the system may be interconnected by any form or medium of digital data communication (e.g., a communication network). The computer system may include clients and servers, which may be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments may also be implemented in combination in a single embodiment in part or in whole. Conversely, various features that are described in the context of a single embodiment may also be implemented in multiple embodiments separately or in any suitable sub-combination. Moreover, although features may be described herein as acting in certain combinations and/or initially claimed as such, one or more features from a claimed combination may in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

1. A method for virtual food product development, the method comprising:
receiving, from an imaging system, two-dimensional (2D) data of food products in a production line at a plant;
converting the 2D data of the food products into three-dimensional (3D) mesh data of the food products based on applying a neural network (NN) to the 2D data;
generating a dataset of synthetic food product pieces based on applying an artificial intelligence (AI) model to the 3D mesh data of the food products;
simulating, in a simulation engine, a process for packaging the synthetic food product pieces in the dataset; and
returning simulation results in response to simulating the process for packaging the synthetic food product pieces in the dataset.

2. The method of claim 1, wherein the 2D data comprises at least one video or at least one image of the food products as the food products undergo a production process in the production line in the plant.

3. The method of claim 1, wherein converting the 2D data of the food products into the 3D mesh data of the food products comprises:
transforming the 2D data into point cloud data; and
providing the point cloud data as input to the NN to generate the 3D mesh data of the food products.

4. The method of claim 1, wherein the AI model comprises a Soft Point Flow NN that was trained per food product type to learn transformations of the 3D mesh data of the food products to representative shapes of the food products.

5. The method of claim 1, wherein the AI model comprises an Unpaired Neural Implicit Shape Translation (UNIST) network that was trained to transform initial flat model shapes of the food products into finished 3D model shapes of the food products.

6. The method of claim 1, wherein the simulating comprises providing the dataset of synthetic food product pieces as input to a simulation model that was trained to determine packaging parameters for the food products based on the simulating, the packaging parameters including at least one of food product fill height in a package and food product headspace in the package.

7. The method of claim 1, further comprising generating recommendations for adjusting a process for producing the food products or adjusting the process for packaging the food products based on the simulation results.

8. The method of claim 7, wherein generating the recommendations comprises determining equipment controls or control modifications that cause, when automatically executed by equipment in the plant, an adjustment of size of the food products during production of the food products.

9. The method of claim 1, further comprising iteratively training the NN or the Al model based on user responses to the simulation results.

10. The method of claim 1, wherein the AI model comprises a NN trained to perform at least one of: (i) transform initial shapes of the food products into finished 3D model shapes of the food products, (ii) predict a shape of finished food products based on a set of parameters, and (iii) predict a shape of unfinished food products based on a set of parameters, wherein the set of parameters are based on desired finished food products.

11. The method of claim 1, wherein the AI model is configured to generate output indicating a set of parameters required to produce a desired shape for the food products.

12. A system for virtual food product development, the system comprising:
an imaging system comprising at least one camera that is configured to capture 2D data of food products in a production line at a plant; and
a computer system in network communication with the imaging system, wherein the computer system is configured to perform operations comprising:
receiving, from the at least one camera of the imaging system, the 2D data of the food products;
converting the 2D data into 3D mesh data of the food products based on applying a first model to the 2D data;
generating a dataset of synthetic food product pieces based on applying a second model to the 3D mesh data of the food products;
running a simulation of a process for packaging the synthetic food product pieces in the dataset; and
returning simulation results in response to running the simulation.

13. The system of claim 12, wherein the 2D data comprises videos or images of the food products as the food products undergo a production process in the production line in the plant.

14. The system of any claim 12, wherein converting the 2D data of the food products into the 3D mesh data of the food products comprises:
transforming the 2D data into point cloud data; and
providing the point cloud data as input to the first model to generate the 3D mesh data of the food products.

15. The system of claim 12, wherein the second model comprises a Soft Point Flow NN that was trained per food product type to learn transformations of the 3D mesh data of the food products to representative shapes of the food products.

16. The system of claim 12, wherein the food products comprise (i) existing food products that are produced and packaged in the production line at the plant or (ii) food products in a virtual development phase.

17. The system of claim 12, wherein the simulation further comprises a process for producing the food products at the plant.

18. The system of claim 12, wherein running the simulation comprises providing the dataset of synthetic food product pieces as input to a simulation model that was trained to run the simulation to one or more simulation parameters.

19. The system of claim 18, wherein the simulation model was trained to determine packaging parameters for the food products based on the simulation, the packaging parameters including (i) a food product fill height in a package or (ii) a food product headspace in the package.

20. The system of claim 12, wherein the operations further comprise determining equipment controls that, when executed by equipment in the plant, automatically cause an adjustment of size of the food products during production of the food products.
